(19) United States
(12) Patent Application Publication
(10) Pub. No.: US 2019/0215308 A1
(43) Pub. Date: Jul. 11, 2019

(54) SELECTIVELY SECURING A PREMISES NETWORK

(71) Applicant: FeyziLogic Co., Atlanta, GA (US)

(72) Inventors: Araz Feyzibehnagh, Sandy Springs, GA (US); Roshan Daneshvaran, Atlanta, GA (US)

(73) Assignee: FeyziLogic Co., Atlanta, GA (US)

(21) Appl. No.: 15/862,672

(22) Filed: Jan. 5, 2018

(51) Int. Cl. H04L 29/06

(52) U.S. Cl. CPC H04L 63/0272; H04L 63/20; H04L 63/029; H04L 63/0457

(57) ABSTRACT

Described herein are embodiments of a computer networking system for selectively securing traffic flows based on characteristics of those traffic flows, by selecting security parameters for each traffic flow based on the characteristics of the traffic flow. In some embodiments, the traffic flows may be intercepted as they leave one network (e.g., a network associated with a premises), outbound to another network. The traffic flows may be transmitted to the other network in accordance with the selected security parameters. In some embodiments, transmitting the traffic flows in accordance with the security parameters may include selectively routing each traffic flow via a selected network path, from a group of paths with different security parameters. Routing the traffic over paths having different security parameters may include, in some embodiments, transmitting the traffic via different tunnels having different security parameters. Some such different tunnels may be different virtual private networks (VPNs).

### TECHNICAL FIELD

Some embodiments described herein are directed generally to the field of computer networking, and more particularly to techniques for routing user traffic. More particularly, some embodiments relate to adapting the security applied to user traffic based on security parameters and characteristics of the traffic. In addition, some embodiments relate to a device for use in a home network that selectively routes traffic flows along one of multiple different network paths, including virtual private network tunnel connections, based on characteristics of the traffic flow.

### BACKGROUND

Private networks, such as networks for use by employees of a business, are often limited to devices at a particular physical premises, with devices outside that premises (e.g., at other businesses) unable to communicate to the private network. Preventing outsiders from communicating to the private network may reduce the vulnerability of the network to attack, snooping of traffic, or other risks.

However, there may be times when it is advantageous to permit remote access to the network by authorized people. For example, employees may occasionally work remotely from the premises of the business (e.g., work from home) and require access to devices, data, etc. of the network to work effectively.

A virtual private network (VPN) is a networking tool that allows users to create or extend a private network using an underlying public (not private) network like the Internet. Using a VPN, traffic is secured (e.g., by encrypting the traffic) before being sent over a public network to the private network. The traffic is often metaphorically described as being transmitted via a secure “tunnel” through the public network, where the tunnel provides security and opacity of the data to the public network, and the data is only unencrypted and visible at either end of the tunnel (e.g., the user's remote computer and the business' premises). Any information relevant to the private network, therefore, is not visible while traversing the public network. Accordingly, using VPNs, security and privacy can be increased.

### SUMMARY

Some embodiments provide for computer networking systems and methods for selectively securing traffic flows based on characteristics of those traffic flows, by selecting one or more security parameters for each traffic flow based on the characteristics of the traffic flow.

In one embodiment, a method is provided. The method includes selectively securing a plurality of outbound traffic flows based on one or more characteristics of each traffic flow, the plurality of outbound traffic flows being outbound from a first network associated with a premises, the selectively securing including: 1) intercepting the plurality of outbound traffic flows at a boundary between the network associated with the premises and a second network to which the plurality of outbound traffic flows are communicated and 2) for each traffic flow of the plurality of outbound traffic flows, selecting one or more security parameters for the traffic flow based on one or more characteristics of the traffic flow; and securing the traffic flow at least in part by transmitting the traffic flow to the second network according to the one or more security parameters.

In another embodiment, an apparatus is provided to be connected between one or more devices of a first network associated with a premises and a second network by which the one or more devices of the first network communicate to the Internet. The apparatus includes: at least one processor; and at least one storage medium having encoded thereon executable instructions that, when executed by the at least one processor, cause the at least one processor to carry out a method. The method includes: selectively securing a plurality of outbound traffic flows based on one or more characteristics of each traffic flow, the plurality of outbound traffic flows being outbound from the one or more devices of the first network to the second network, the selectively securing including: 1) intercepting the plurality of outbound traffic flows with the apparatus and 2) for each traffic flow of the plurality of outbound traffic flows, selecting one or more security parameters for the traffic flow based on one or more characteristics of the traffic flow and securing the traffic flow at least in part by transmitting the traffic flow to the second network according to the one or more security parameters.

In a further embodiment, a network associated with a premises, is provided. The network including: a gateway to interface between the network and a second network, the second network providing the network with access to the Internet; one or more devices connected to the network and transmitting data to be received by the one or more devices and/or to be communicated to the second network; and a device connected between the one or more devices and the gateway, the device being configured to carry out a method of: 1) intercepting a plurality of outbound traffic flows from the one or more devices to the second network, each of the traffic flows being directed to one or more destinations other than the device; 2) selectively securing the plurality of outbound traffic flows based on one or more characteristics of each traffic flow. The selectively securing includes, for each traffic flow of the plurality of outbound traffic flows: 1) in response to determining that the one or more characteristics satisfy at least one first criteria, transmitting the traffic flow to the gateway for transmission to the second network; 2) in response to determining that the one or more characteristics satisfy at least one second criteria, transmitting the traffic flow to the gateway and to a first destination of the traffic flow via a first tunnel, the first tunnel terminating at a second destination different from the first destination of the traffic flow; and 3) in response to determining that the one or more characteristics satisfy at least one third criteria, transmitting the traffic flow to the gateway and to the first destination of the traffic flow via a second tunnel, the second tunnel terminating at a third destination different from the first destination of the traffic flow, the first tunnel and the second tunnel being associated with different security parameters.

In another embodiment, a method is provided. The method includes, in response to intercepting a message requesting that a first computing device associated with a first numeric network address provide a corresponding numeric network address that corresponds to a network name, editing the message to direct the message to a second computing device associated with a second numeric network address and request that the second computing device provide a corresponding numeric network address that corresponds to the network name; and transmitting the message to the second computing device.

In a further embodiment, a system is provided. The system includes a first computing device and a second computing device, the first computing device being configured to perform a first method including: in response to receipt of a request for a numeric network address corresponding to a network name, determining a categorization of content associated with the network name; and based on the categorization, selectively responding to the request with either the numeric network address corresponding to the network name or a second numeric network address that does not correspond to the network name. The second computing device is configured to perform a second method including: in response to intercepting a first message requesting that a third computing device associated with a first numeric network address provide a corresponding numeric network address that corresponds to an identified network name, edit the first message to direct the first message to the first computing device and request that the first computing device provide the corresponding numeric network address that corresponds to the identified network name; and transmit the first message to the first computing device.

In another embodiment, a method is provided. The method includes requesting configuration information from a server; receiving, in response to the request, a plurality of sets of security parameters; selecting one of the plurality of sets of security parameters; and selecting, from a plurality of relay servers, a relay server to be used as a destination of traffic flows secured using the selected set of security parameters.

In a further embodiment, a system is provided. The system includes a first computing device, the first computing device being configured to perform a first method comprising: requesting configuration information from a server; receiving, in response to the request, a plurality of sets of security parameters; and selecting one of the plurality of sets of security parameters; selecting, from a plurality of relay servers, a relay server to be used as a destination of traffic flows secured using the selected set of security parameters.

In another embodiment, there is provided at least one non-transitory computer-readable storage medium having encoded thereon executable instructions that, when executed by at least one processor, cause the at least one processor to carry out any one or any combination of the foregoing methods.

In a further embodiment, there is provided an apparatus comprising at least one processor and at least one non-transitory storage medium. The at least one storage medium has encoded thereon executable instructions that, when executed by the at least one processor, cause the at least one processor to carry out any one or any combination of the foregoing methods.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

### BRIEF DESCRIPTION OF DRAWINGS

The accompanying drawings are not intended to be drawn to scale. For purposes of clarity, not every component may be labeled in every drawing. In the drawings:

FIG. 1 shows an illustrative environment in which some embodiments of the technology described herein may operate.

FIG. 2 shows an illustrative block diagram of computing devices for configuring and utilizing network paths, in accordance with some embodiments of the technology described herein.

FIG. 3 shows an illustrative process for capturing a DNS request, in accordance with some embodiments of the technology described herein.

FIG. 4 shows an illustrative process for routing network traffic between a user device and destination server along a VPN pathway, in accordance with some embodiments of the technology described herein.

FIG. 5 shows an illustrative process for selecting a network path for routing user traffic, in accordance with some embodiments of the technology described herein.

FIG. 6 shows an illustrative process for selecting a network path for routing user traffic, in accordance with some embodiments of the technology described herein.

FIG. 7 shows an illustrative process for selecting a network path for routing user traffic, in accordance with some embodiments of the technology described herein.

FIG. 8 shows an illustrative process for selecting a network path for routing user traffic, in accordance with some embodiments of the technology described herein.

FIG. 9 shows an illustrative process for computing an entropy score for network traffic, in accordance with some embodiments of the technology described herein.

FIG. 10 shows an illustrative embodiment for determining a cost to value ratio for network traffic, in accordance with some embodiments of the technology described herein.

FIG. 11 shows an illustrative process for connecting a VPN device to a relay server, in accordance with some embodiments of the technology described herein.

FIG. 12 shows an illustrative process for detecting the disconnection of a VPN device, in accordance with some embodiments of the technology described herein.

FIG. 13 shows an illustrative process for filtering content by capturing a DNS request, in accordance with some embodiments of the technology described herein.

FIG. 14 shows an illustrative process for filtering content received through a VPN, in accordance with some embodiments of the technology described herein.

FIG. 15 shows an illustrative computing system on which any aspect of the present disclosure may be implemented.

### DETAILED DESCRIPTION

Described herein are embodiments of a computer networking system for selectively securing traffic flows based on characteristics of those traffic flows, by selecting one or more security parameters for each traffic flow based on the characteristics of the traffic flow. In some embodiments, the traffic flows may be intercepted as they leave one network (e.g., a network associated with a premises), outbound to another network. The traffic flows may be transmitted to the other network in accordance with the selected security and/or encoding parameters. In some embodiments, transmitting the traffic flows in accordance with the security parameters may include selectively routing each traffic flow via a selected network path, from a group of paths, where the selected path has the selected security parameters. In such embodiments, the traffic flows may be selectively routed over different paths with different security parameters. Routing the traffic over paths having different security parameters may include, in some embodiments, transmitting the traffic via different tunnels having different security and/or encoding parameters. Some such different tunnels may, in some embodiments, be different virtual private networks (VPNs).

In some embodiments described herein, a security device receives traffic entering or leaving a local network, for example by being connected between a device that is a modem and/or gateway at a boundary between a local network of a premises (e.g., a residential premises) and another network (e.g., a network of an internet service provider (ISP) for the premises), and a router or switch for the premises' local network, such as a wireless access point for the premises. By being connected in this manner, the device may be able to receive much, most, or even all of the traffic inbound to or outbound from the local network of the premises. The security device may then identify individual traffic flows (e.g., transport-layer connections) within the traffic and selectively secure the traffic flows with different security and/or encoding parameters. This may include repackaging traffic flows for transmission via one or more tunnels with different security parameters.

The inventors have recognized and appreciated that security and privacy of Internet and network communications is a growing concern. Some of those concerns focus on hackers or other bad actors intercepting and misusing data from the network traffic, such as for criminal purposes. The inventors have recognized and appreciated, however, that another source of concern, which many people conventionally considered somewhat mundane, is the risk of a consumer's Internet Service Provider (ISP) monitoring the consumer's communications for the purpose of profiling the consumer for marketing purposes, or monetizing the consumer's behavior by selling information regarding the consumer's (or groups of consumers) network traffic habits. Consumers may not be aware that such monetization of their data is taking place. When they are, consumers may desire to take steps to prevent that monetization or make it more difficult. The inventors have also recognized and appreciated, however, that conventional security and privacy technologies require careful and rigorous configuration, and as a result, may only provide high security for users with high technical skill. Lay users may find existing security and privacy techniques difficult to use, or difficult to use correctly. As a result, users may not be able to use the conventional technologies, or may misconfigure the technologies such that while the users believe they have high security or privacy, they are not as protected as they believe they are.

For example, Virtual Private Networks (VPNs) are one tool that may aid a user in protecting their traffic from inspection by an ISP. But, conventional VPN implementations may require complicated configuration and administration actions from users. Some conventional VPN implementations may also significantly degrade network performance. For example, some conventional implementations sit within a wireless local network and may greatly increase the required number of transmissions in order to receive and retransmit traffic over the VPN. Some conventional VPN implementations treat all applications, protocols, and/or traffic the same, which may lead to inefficient performance. For example, different network based application may have different tolerances for lag induced by encrypting or re-routing VPN traffic. The inventors have appreciated that different applications may benefit from network paths that allow for more than one level of secrecy, encryption, compression, latency, and/or other suitable parameters.

Additionally, some conventional VPN solutions route all available traffic over the VPN. However, some destination servers receiving user traffic may be configured to reject traffic that has been routed over a VPN and deny service to users of the VPN solution. For example, content streaming services, such as NETFLIX® or HULU®, may have service restrictions, such as geographic boundaries, and when a VPN is detected (which some skilled users could use to circumvent those service restrictions) may return an error message to users instead of desired content. Such media streaming services form a substantial and increasing share of a typical user's network traffic. When such a substantial share of the user's traffic is incompatible with a VPN, even where the user is able to configure and operate a VPN, the user may cease using the VPN to avoid difficulties.

Other conventional security techniques rely on identifying a type of each device in a home network, and customizing security parameters that are used for each device's traffic. Such an approach is again difficult for lay users to use, as it requires installation within a network and careful configuration regarding network contents. Additionally, the inventors have recognized and appreciated that it is of limited utility for many devices used in a typical home. Some devices may transmit traffic of only a single type, such as Internet-of-Things (IoT) devices that perform only a single function (e.g., a thermostat) and only communicate data regarding that function. In such a case, it may be acceptable to determine security parameters to be applied for all traffic for that device. Other devices, however, perform multiple different functions and transmit data of very different type or content. Personal computers, mobile devices (smart phones, tablets), virtual assistants (e.g., the ECHO® devices available from Amazon.com, Inc.), video gaming systems, and others may transmit very different types of traffic over time. The inventors recognized and appreciated that, at least for these devices, selecting a set of security parameters based merely on the identity of the device may not be feasible, as different security parameters may not be suitable for different types of traffic.

The inventors recognized and appreciated the desirability of techniques for securing network traffic that are easy to configure and use for lay users, while providing robust and flexible security for different types of traffic.

Described herein are embodiments of systems and techniques for intercepting and selectively securing network (e.g., Internet) traffic. In some embodiments, techniques described herein may identify different traffic flows within network traffic leaving a network. Such different traffic flows may be, for example, different transport layer connections, where a transport layer connection may be a connection in accordance with a protocol that is a Transport Layer protocol in accordance with the Open Systems Interconnection (OSI) model. Such traffic flows may additionally or alternatively include traffic being communicated to or with a particular destination, such as a particular computing device or set of computing devices associated with a numeric network address (e.g., an IP address) or a network name (e.g., a domain name or host name). When a traffic flow is identified, one or more characteristics of the traffic flow may also be identified. The characteristic(s) may be identified from a review of contents of one or more datagrams of the traffic flows, such as the contents of one or more headers of the datagram(s) and/or one or more payloads of the datagram(s). The header(s) that are analyzed may include any of multiple headers of a message or headers of a set of messages, including application-layer headers that may be separated among one or more datagrams transmitted according to lower-level protocols. Based on the characteristic(s), one or more security parameters to be applied to the traffic flow may be identified. The traffic flow may then be secured in accordance with the identified security parameters.

In some embodiments, traffic flows may be intercepted as they exit a network associated with a premises. The traffic flows may be communicated within the premises by different devices on the network, and the different devices may transmit the traffic flows to destinations outside the network. In some such embodiments, as the traffic flows leave the network or after the traffic flows leave the network, the traffic flows may be analyzed to determine the characteristic(s) and the security parameter(s) may be selected. In some cases, the traffic flows may already be secured according to one or more security techniques prior to being intercepted and analyzed, such as being encrypted. In some such cases, security parameters that are selected from the analysis of one or more datagrams of the traffic flow may be for additional security that is added to the traffic flow or otherwise use to additionally secure the traffic flow before transmission.

In some embodiments, interception of traffic flows leaving a network associated with a premises may be performed by a security device that is located at an interface between the network associated with the premises and another network. The other network may be, for example, a network of an ISP for the premises. The security device may be located between each of the devices of the network of the premises and a gateway for the premises network. For example, in some networks, the device may be located between a device that acts as one or more of a router, switch, or network address translator (NAT) for the premises network and a modem for the premises network, where the modem serves as a gateway to connect the premises network to the ISP network. There may be a single path between the device acting at the router/switch/NAT and the modem, and the security device may sit along that path, such that in some embodiments, all communications between the premises network and the ISP network pass through the security device. The security device may intercept and relay communications between the premises network and the ISP network.

In some embodiments, the security device may add security to traffic flows, in accordance with security parameters individually selected for the traffic flows from analysis of datagrams for the traffic flows, by transmitting the traffic flows via a selected tunnel from a set of tunnels, where each of the tunnels is associated with a different set of security parameters. When a traffic flow is transmitted via a tunnel, the data of the traffic flow (headers and/or payload of datagrams of the traffic flow) are secured using the security parameters for that tunnel. Each of the tunnels may terminate at a computing device that, upon receipt of traffic flows via the tunnels, will relay the traffic flows to the intended destination of the traffic flows. Each computing device may receive traffic flows transmitted via different tunnels from different premises networks. In this way, traffic flows leaving a premises network may be secured while transiting an ISP network (as a result of the tunneling) and make inspection and/or interception of the traffic flows by an ISP difficult. In some embodiments, one or more of the tunnels is a Virtual Private Network (VPN). Different VPNs may have different security parameters, such as whether or not the data conveyed via the VPN is compressed or whether it is encrypted. In some embodiments, two VPNs may have the same or similar security parameters, but may differ in other attributes, such as bandwidth or geographic location of a termination point.

While in examples above, security parameters are selected and applied based on analysis of datagrams, it should be appreciated that in some embodiments, based on characteristics of a traffic flow, a determination may be made not to further secure a traffic flow. This decision may be made, for example, based on a destination of a traffic flow. If it is known, for example, that a destination of a traffic flow is a system/service that will receive communications that arrive via a tunnel such as a VPN (e.g., a multimedia streaming service such as NETFLIX®), then the traffic may be transmitted by a security device of a premises network to an ISP network largely in the same manner in which the traffic arrived at the security device, without additional security.

In some embodiments, a security device for a premises network may be configured to receive traffic leaving the premises network and may be used to enforce network policies, for example parental blocking. In some embodiments, the security device may prevent users from circumventing the security device by disconnecting the security device from the premises network, such as by connecting the premises network directly to a modem or other gateway for the premises network without the security device. A service associated with the security device may detect and/or log disconnections of the security device from the network, for example by periodically transmitting heartbeat pings between the security device and another computing device outside of the premises network, such as a computing device that communicates with the security device via the Internet. In some embodiments, users are alerted when the security device is disconnected, such as by transmissions of textual messages via email, text/Simple Messaging Service (SMS)/Multimedia Messaging Service (MMS), by sending push notification to the mobile application, or other messaging systems.

In some embodiments, a security device may act to filter content available to the premises network, such as a web content, by limiting addresses with which devices on the premises network may communicate. For example, the security device may intercept requests transmitted from the premises network that seek to translate a numeric network identifier to a network name, such as by seeking to translate a network name like a domain name into an Internet Protocol (IP) address. In some embodiments, the security device may intercept Domain Name System (DNS) requests or other name translation requests from devices on the local network. The VPN device may identify DNS requests in the network traffic and redirect the requests. In some embodiments, a server receiving redirected DNS requests may respond with information categorizing and/or blocking the traffic, e.g. to provide information for parental blocking or redirecting the user to a webpage indicating the requested domain was blocked. The VPN device may route traffic based on the domain name and the associated IP address returned from the request.

In some embodiments, the security device may be configured to self-provision information on security parameters or sets of security parameters, and/or characteristics on which to base selections of security parameters or sets of security parameters, without or with limited user configuration. In some such embodiments, the security device may securely transmit configuration information to a server and receive security configuration information in return. The security configuration information may include information on security parameters. In some embodiments that use tunnels to securely transmit traffic flows, including some embodiments that use VPNs, the security configuration information may include information regarding termination points of the tunnels or VPNs. The information regarding termination points may include addresses for termination points to be used, and/or information on servers that may be used by the security device to determine termination points for each tunnel. For example, the servers may be load balancing servers that may aid in instantiating and/or identifying a server to serve as a termination point for a tunnel that starts at the security device.

Described below are various illustrative embodiments of systems and techniques. It should be appreciated, however, that embodiments are not limited to acting in accordance with any of the described embodiments, as other embodiments are possible.

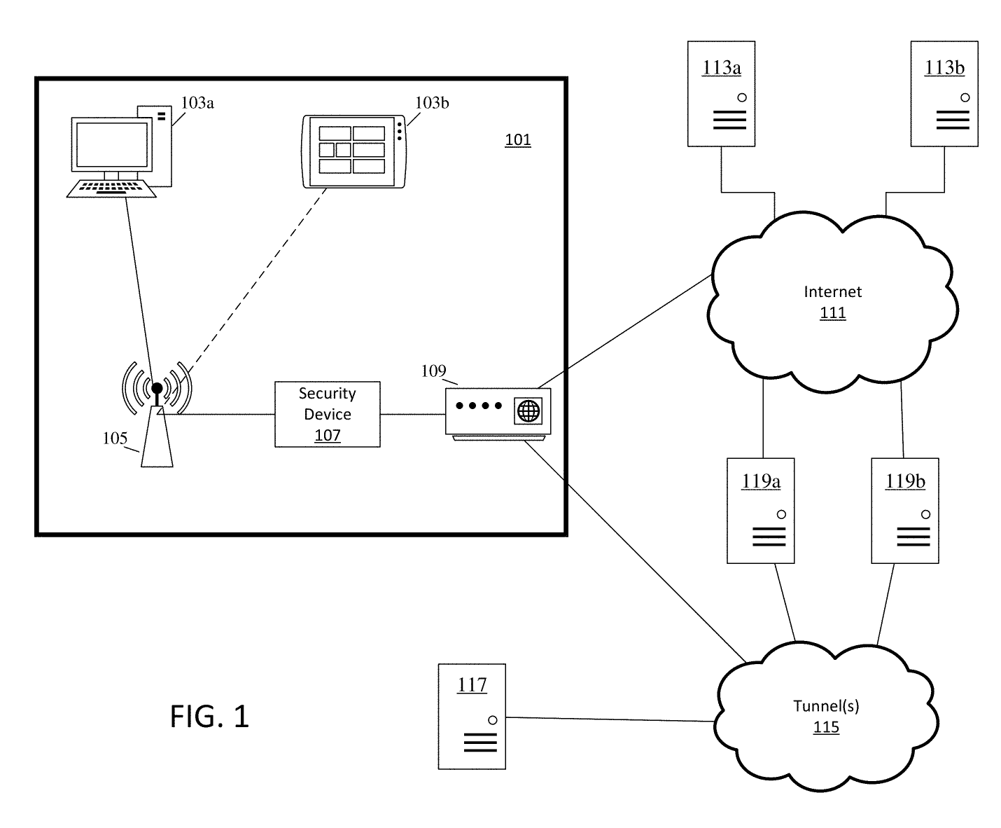

FIG. 1 shows an illustrative environment in which some embodiments of the technology described herein may operate. FIG. 1 illustrates premises 101, which may be a home or office building, or any other type of premises for a residential, commercial, industrial, government, or other purpose, and that may include devices communicating via a computer communication network disposed within or otherwise for that premises. The computer communication network may be any suitable network, including a wired and/or wireless network operating according to any suitable networking protocol or combination of networking protocols. In some embodiments, the network may be a local area network (LAN), including a wireless LAN (WLAN) operating according to a protocols such as any of the protocols within the Institute of Electrical and Electronics Engineers' (IEEE's) 802.3 or 802.11 suites of protocols. Accordingly, the network may in some embodiments be an Ethernet network and/or an ISM-band (industrial, scientific, medical) wireless network.

The premises network may include a gateway 109 that separates the network of the premises 101 from the Internet 111, including from the network of an Internet Service Provider (ISP) for the premises 101. The gateway 109 may, in some embodiments, be a modem. In cases in which the ISP of the premises 101 operates a “cable” network, gateway 109 may be a modem operating according to a Data Over Cable Service Interface Specification (DOCSIS), including any suitable version of the DOCSIS protocol. In such embodiments in which the gateway 109 is a cable modem, the network of the ISP for the premises 101 may include equipment to enable cable Internet access, such as a cable modem termination system (CMTS). However, it should be appreciated that the network of the ISP of the premises 101 is not limited to being implemented in any particular manner. In other embodiments, the ISP network may be a fiber optic network (a fiber to the premises (FTTP)) network, a digital subscriber line (DSL) network, or any other manner of implementing last minute telecommunications or otherwise providing the premises 101 with access to the Internet. The Internet 111 may be implemented in any suitable manner.

The gateway 109 may communicate all traffic between the network of the premises 101 and the Internet 111, including all traffic between the network of the premises 101 and the network of the ISP for the premises 101. As part of communicating all traffic, the gateway 109 may communicate all traffic flows between the network for the premises 101 and the Internet 111. Each such traffic flow may include one or more datagrams communicated between a source and a destination, which may be communicated as part of requesting, receiving, and/or transmitting particular content. A traffic flow may originate inside the network of the premises 101 (e.g., from one of the devices 103 connected to the network of the premises 101) or originate on the Internet 111, including on the network of the ISP for the premises 101. In some embodiments, some or all of the traffic flows may relate to a set of datagrams exchanged according to a session established in connection with a protocol that is a transport layer protocol in the OSI model, such as the Transmission Control Protocol (TCP). Accordingly, in some embodiments, traffic flows may be communicated according to one or more stateful protocols, such as TCP, or protocols that otherwise include establishing a connection between a sender and a receiver, and the traffic flow may relate to such a connection. The traffic flows may include any suitable content, including web traffic (e.g., web pages), email communications or other messages, streaming media (e.g., music, video, etc.), or any other type of content that may be communicated via the Internet, as embodiments are not limited in this respect.

Techniques described herein may be used to selectively and individually secure each such traffic flow.

The traffic flows communicated by the gateway 109 between the network of the premises 101 and the Internet 111 may include traffic flows communicated with devices including computing devices 103a-b, generically or collectively referred to herein as devices 103. Devices 103 are illustrated in FIG. 1 as including a desktop personal computer 103a and a tablet mobile device 103b, but it should be appreciated that these are merely illustrative examples and that embodiments are not limited to operating with these particular forms of computing devices. Devices 103 may be any suitable device that generates messages to be transmitted via a computer network, or that receives such messages. The devices 103 may therefore include personal computing devices, mobile computing devices, Internet-connected televisions, virtual agents such as voice-enabled devices that perform tasks in response to user speech input (e.g., AMAZON® ECHO® products), Internet-of-Things devices like connected home appliances (including Internet-connected thermostats and other appliances), or other devices. Such devices may communicate via the network of the premises 101 via either or both of a wired or wireless connection.

The network of the premises 101 may also include one or more networking infrastructure devices. Such devices may include switches, routers, wireless access points, firewalls, network address translators (NATs), or other devices, including devices that may perform one or more networking infrastructure functions. In the example of FIG. 1, the network of the premises 101 includes a wireless access point 105 with which devices 103 communicate.

The network of the premises 101 may have a topology such that all devices 103 communicating on the network communicate with the Internet 111 and with each other via the access point 105, such that all traffic flows to or from the devices 103 pass through both access point 105 and gateway 109. In this way, all traffic flows communicated between the Internet and the network of the premises 101 may pass between the access point 105 and the gateway 109.

In accordance with techniques described herein, the network of the premises 101 may further include a security device 107 that intercepts and/or inspects traffic flows that are being communicated between the devices 103 of the network of the premises 101 and the Internet 111. Due to its position in the network between the gateway 109 and the rest of the devices of the network, the security device 107 may receive all traffic flows being communicated between the network and the Internet 111 (including the network of the ISP of the premises 101). The security device 107 may not be a source or destination of such traffic flows, but may act as a bridge or relay device, communicating the traffic flows between the gateway 109 and the access point 105 or other components of the network of the premises 101.

The security device 107 accordingly receives traffic flows (despite not being a source or destination of the traffic flows) and may implement one or more techniques described herein to selectively secure the traffic flows using one or more security and/or encoding parameters. More particularly, as discussed briefly above and in detail below, the security device 107 may be operable and/or configured to selectively and individually secure traffic flows from the network of the premises 101 (including from devices 103) based on characteristics of each traffic flow.

The traffic flows may be transmitted from the network of the premises 101, including from the devices 103, to one or more destinations on the Internet 111, illustratively shown in FIG. 1 as the destination servers 113a-113b. In accordance with techniques herein, the security device 107 may intercept the traffic flows and communicate datagrams of at least some of the traffic flows to the destination servers 113a-b via tunnels 115 and relay servers 119a-119b. The relay servers 119a-119b may, in turn, communicate the datagrams of the traffic flows to the intended destinations of those datagrams, including the destination servers 113a-113b.

To secure traffic flows, in accordance with some embodiments described herein, the security device 107 may communicate with an intelligence server 117 and one or more relay servers 119a-b through network tunnels 115. The tunnels 115 are implemented using network “tunneling” technologies that allow for creating a secure path for traffic through one or more other networks, including the network of the ISP for the premises 101 and the Internet 111, to make inspection or interception of the traffic (e.g., by an ISP of the premises 101) sent via the tunnels 115 more difficult. Such tunneling technology may include using cryptography to encode the datagrams sent via the tunnel (including a header and a payload of such datagrams) between a start point and an end point of the tunnel. When such tunneling technology is used, a tunnel 115 may be created between a start point and an end point, which in this case could respectively be the security device 107 and one of the relay servers 119a-b. Once the tunnel is created, data can be sent over the tunnel, including the traffic flows that the security device 107 intercepts. In accordance with techniques described herein, the security device 107 may send some traffic flows via one tunnel 115 to relay server 119a and other traffic flows via another tunnel 115 to relay server 119b. When the relay servers 119a-b receive the traffic flows, the relay servers 119a-b may communicate the traffic flows to the destinations of those traffic flows as if the traffic flows had been sent from the gateway 109 without intervention by the security device 107. Or, in some embodiments, the relay devices 119a-b may edit the “source” address on datagrams of the traffic flows to remove an address for the network of the premises 101 and insert an address for the relay server 119a-b that received and transmitted the datagram/traffic flow. By replacing the source address, when a destination server 113a-b prepares and sends a response to the datagram or traffic flow, the destination server 113a-b will send the response to the source of the datagram/traffic flow, which in this case will appear to be one of the relay servers 119a-b. The relay servers 119a-b may then communicate the response from the destination server 113a-b to the device 103 that initiated the traffic flow via the tunnel 115 and the security device 107.

Use of the tunnels 115 and the relay servers 11a-b allows for making inspection or interception of traffic flows from the premises 101 more difficult. Securing traffic using the tunnels 115 prevents easy inspection of the data sent or received from the premises 101. In addition, the relay servers 119a-b may be geographically remote from one another and connected to the Internet 111 at different places. Use of the different relay servers therefore allows for geographically dispersing traffic sent or received by the premises 101, creating an additional hurdle to observing traffic sent or received by the premises 101. In addition, other security devices 107 for other premises may be communicating traffic flows to relay servers 119a-119b using other tunnels 115. Traffic being sent or received by the relay servers 119a-b may therefore be mingled with traffic for other premises, making identification of traffic for the premises 101 even more difficult.

While for ease of illustration in FIG. 1 the tunnels 115 are shown separate from the Internet 111, it should be appreciated that tunnels 115 are a manner of communicating data securely via the Internet 111 or other networks, such tunnels 115 may traverse one or more networks including the Internet 111, and thus may overlap with the Internet 111. The tunnels 115 may be implemented using any suitable tunneling technology, including virtual private networks (VPNs). The relay servers 119a-b may be any suitable device to act as a termination point (and may be referred to herein as a virtual termination point (VTP)) for a VPN 115 and that may be configured to forward traffic received via the tunnel 115 to a destination server 113a-b. The security device 107 may therefore be connected to the relay servers 119a-b via the Internet 111 and the gateway 109 (despite being illustrated as connected via the tunnels 115). The relay servers 119a-b may also be connected via the Internet 111 to destinations of traffic flows, illustratively shown in FIG. 1 as the destination servers 113a-b.

Processes for intercepting, securing, and transmitting traffic flows are described in detail below. In brief, the security device 107 may identify, within traffic being communicated between the network for the premises 101 and the Internet 111, individual traffic flows, determine characteristics of the traffic flows, and selectively secure the traffic flows with different security and/or encoding parameters, such as different levels of secrecy, encryption, compression, latency, and/or other suitable parameters.

In some embodiments, the security device 107 intercepts and retransmits the traffic flows in accordance with the security parameters by selecting a network path from a group of paths for routing each traffic flow, where the selected path has the selected security parameters. In some embodiments, the security parameters and/or network path are selected based on characteristics of the traffic flows, such as networking protocol, networking port, entropy, latency demands, a category of the application generating the traffic, or any suitable characteristic. The characteristic(s) may be identified from a review of contents of one or more datagrams of the traffic flows, such as the contents of one or more headers of the datagram(s) and/or one or more payloads of the datagram(s). The header(s) that are analyzed may include any of multiple headers of a message or headers of a set of messages, including application-layer headers that may be separated among one or more datagrams transmitted according to lower-level protocols. In the example of FIG. 1, the paths may include the tunnels 115. The security device may selectively route each traffic flow that travels through the access point 105 from any of the user devices 103a-b along one or more network paths through a selected one of the tunnels 115 or directly over the Internet 111 to the destination servers 113a-b.

The security device 107 may make one or more determinations regarding a traffic flow to determine that the traffic flow should be transmitted via the Internet 111 rather than via one of the tunnels 115. As discussed above, some destinations (e.g., one of the destination servers 113a-b) may be configured to reject traffic received via a VPN, for example to enforce service restrictions of a multimedia streaming service. Some such destination servers may be configured to detect presence of a VPN by, for example, detecting a threshold number of traffic flows are being received by the server from, or being transmitted by the server to, the same location and determine that the location must be the termination point of a VPN and/or a relay server that is aggregating traffic for one or more recipients.

The security device 107, in some embodiments, provides varying levels of security based on security parameters, which may be based in part on whether the destination controls access based on presence of a VPN. In the event that the destination address is configured to reject VPN traffic, and security device 107 is configured to selectively route traffic using one or more VPNs, for traffic to be exchanged with that destination address the security device 107 may route the user traffic over the Internet 111 without using a VPN. The traffic may also be routed directly to the destination server according to parameters specified in the traffic, e.g. using a specified protocol, without any additional security or encoding parameters being applied.

For example, a user device 103a may generate a traffic flow including one or more datagrams addressed, by a numeric network identifier included in the datagram(s), for the destination server 113a. As the traffic flow is being transmitted from the network of the premises 101 toward destination server 113a, the traffic flow may be intercepted by the security device 107. The security device 107 may determine one or more parameters of the traffic flow and, based on characteristics of the traffic flow, determine whether and how to route the traffic flow from the network of the premises 101. For example, the security device 107 may determine whether to route the traffic flow over the Internet 111 without applying any encryption or additional security parameters to the traffic, or whether to route the traffic flow via one of the tunnels 115. Examples of techniques the security device 107 may use to make this determination are described in detail below. In brief, one criterion the security device 107 may evaluate is whether the network address included in the datagrams (in this case, for the destination server 113a) is for a server or a service that is known to be configured to reject traffic transmitted over a VPN. In this example, the security device 107 may have a stored list of such servers and determine that the network address included in the datagrams is for a server on the list, and route the traffic flow over the Internet 111 rather than any of the tunnels 115.

To continue the above example, the user device 103b may generate a separate traffic flow to the destination server 113a that is also intercepted by the security device 107, and as a result of the same analysis may be transmitted by the security device 107 over the Internet 111 without encryption. However, the user device 103b may also generate a traffic flow destined for the destination server 113b. The security device 107 may intercept this traffic flow as with the other traffic flows and consider one or more characteristics of the traffic flow. Based on the characteristic(s), the security device 107 may instead determine that this traffic flow is to be routed via one of the tunnels 115, which is a tunnel having security and/or encoding parameters matching security/encoding parameters selected for the traffic flow by the security device 107 based on the characteristic(s) of the traffic flow. The selected tunnel 115 may terminate at the relay server 119a. The relay server 119a may then, upon receipt of the datagrams via the tunnel 115, transmit the datagrams to the destination server 113b indicated by the network address contained within the messages.

Accordingly, the security device 107 and relay servers 119a, 119b may act as bridge relay, bridge, or routing devices along a path between the devices 103 and destination servers 113a, 113b to communicate datagrams between the device 103 and servers 113a, 113b along selected paths, but without acting as a source or destination of any of the datagrams.

In some embodiments, the tunnels 115 may be one or more tunnels that may have different levels of secrecy, encryption, compression, latency, and/or other suitable parameters. It should be appreciated that the tunnels 115 may be implemented as any suitable tunnel, overlay network (e.g., onion routing), or other suitable network protocol, including as a VPN. While VPNs are described herein in various illustrative examples, it should be appreciated that other forms of tunnels may be used in some embodiments and that the discussion of VPNs is not meant to be limiting.

In some embodiments, the security device 107 is connected to multiple tunnels that are each connected to and terminate at different of multiple endpoints. For example, the relay server 119a may be connected to the security device 107 through a first tunnel and the relay sever 119b may be connected to the security device through a second tunnel.

In some embodiments, the intelligence server 117 may store parameters for establishing each of the tunnels, including credentials for establishing secure private connections and addresses of relay servers. In some embodiments, the intelligence server 117 stores information for selectively routing traffic, including associations between domains and/or network address prefixes and security parameters.

In some such embodiments, the intelligence server 117 may be used to configure the security device 107 to establish tunnel (e.g., VPN) connections with the relay servers 119a-b. The security device 107 may request tunnel configuration information from the intelligence server 117. In response to the request, the intelligence server 117 responds with security parameters for establishing the tunnel connections with the relay servers 119a-b. The security device 107 may select, for one or more sets of security parameters, a relay server 119a and/or 119b to use as an endpoint for each tunnel. The intelligence server may also provide load balancing between the relay severs 119a-b based on network proximity (e.g., as measured by ping times) from each relay server to the security device 107 and/or based on the traffic load being handled at each of the relay servers 119a-b.

In some embodiments, the relay servers 119a-b may be additionally configured to filter content in the traffic flow between user devices (e.g., 103a-b) and the destination servers (e.g., 113a-b). For example, the relay servers 119a-b may be configured to block advertising sent from the destination server to the user device, block adult content, or block other content. The relay servers 119a-b may be configured to perform such blocking by reviewing datagrams received by the servers 119a-b via a tunnel 115 or from another source and that is to be sent through a tunnel 115, and determining whether any of the content of the datagrams (e.g., content of the payload of datagrams) satisfies one or more criteria relating to blocked content. Any known techniques for review and blocking of content may be used, as embodiments are not limited in this respect.

It should be appreciated that the relay servers 119a-b may be configured using multiple servers in different suitable configurations. For example, relay servers may be geo-replicated, such that relay servers 119a and 119b may be separated by large geographical distances including being on separate continents. In some embodiments, relay servers 119a-b may each be implemented as pools of physical and/or virtual servers implemented via one or more cloud computing networks and that operate with the same security parameters. In some such embodiments, such pools of physical and/or virtual servers may be used to provide resilience to relay server failures or for load balancing. For example, a tunnel 115 with a set of security and/or encoding parameters may be configured to carry user traffic to relay server 119a. If it is determined (e.g., by intelligence server 117) that server 119a is experiencing high traffic or has experienced a failure, user traffic flows may be forwarded through a similar tunnel 115, with the same or similar security or encoding parameters, to relay server 119b.

While FIG. 1 includes two destination servers 113a-b, two relay servers 119a-b, and one set of tunnels 115, it should be appreciated that embodiments are not limited to operating with any particular number of destinations or destinations of any particular form, and are not limited to operating with any particular number of tunnels or relay device serving as termination points for tunnels. Embodiments operating in accordance with techniques described herein may be used with any suitable destinations and any suitable number of destinations of traffic flows, and may be used with any suitable number of tunnels.

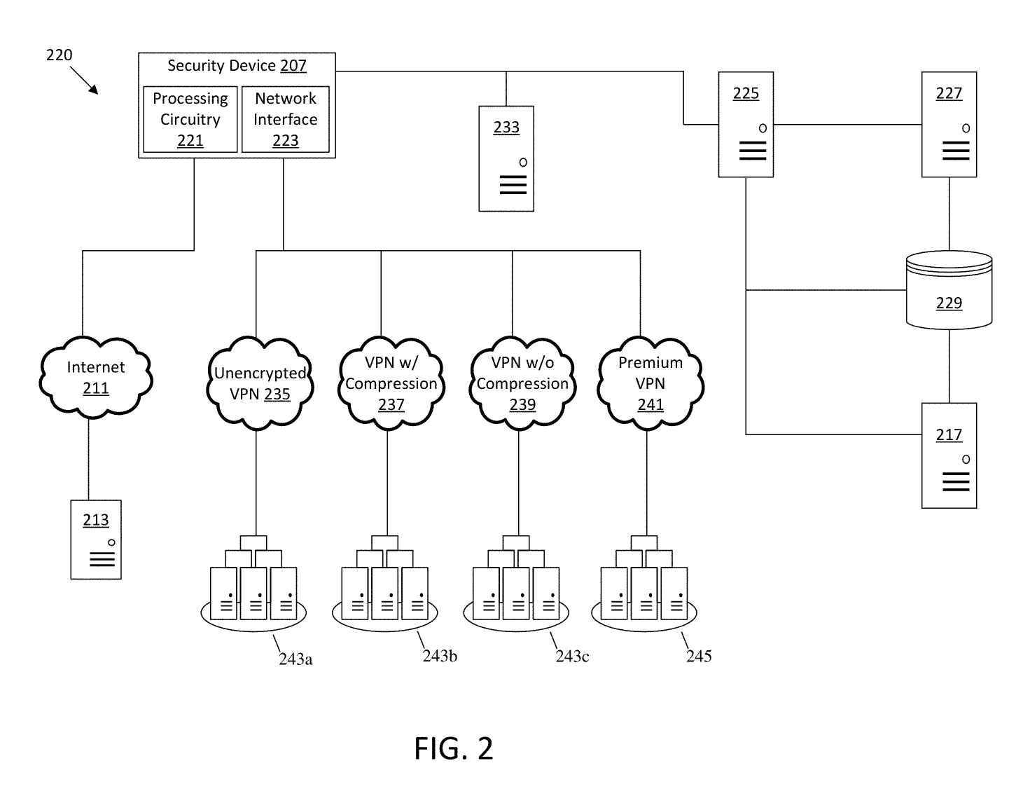

FIG. 2 shows an illustrative block diagram of computing devices for configuring and utilizing network paths, in accordance with some embodiments of the technology described herein. FIG. 2 depicts a system 220 including a security device 207, an API server 225, a certificate authority 227, a database 229, an intelligence server 217, and a naming server 233. The security device 107 may be connected to pools of relay servers 243a-c, 245 via tunnels with different configurations 235-241. More particularly, the security device 207 is connected to a destination server 213 through the Internet 211, relay server pool 243a through an unencrypted VPN 235, relay server pool 243b through a compressed VPN 237, relay server pool 243c through an uncompressed VPN 239, and relay server pool 245 through a premium VPN 241. The different configurations of the different tunnels 235-241 may relate to different security and/or encoding parameters, and the security device 207 may choose a tunnel via which to transmit a traffic flow based on one or more characteristics of the traffic flow. The security device 207 may leverage the devices 213 and 225-233 to establish the tunnels 235-241 and choose between the tunnels 235-241 for securing a traffic flow. In the example of FIG. 2, the tunnels 235-241 are implemented as VPNs, but it should be appreciated that embodiments are not so limited.

The security device 207 may operate in a similar manner as was described with reference to the security device 107 in FIG. 1. In some embodiments, the security device 207 intercepts and retransmits the traffic flows in accordance with selected security parameters by selecting a network path from a group of paths (e.g., using the Internet 211 or one of the VPNs 235, 237, 239, and 241) for routing each traffic flow, where the selected path has the selected security parameters (e.g., encryption or compression). In some embodiments, the security parameters and/or network path are selected based on characteristics of the traffic flows determined by the security device 207, such as networking protocol, networking port, entropy, latency demands, a category of the application generating the traffic, or any suitable characteristic. The security device 207 includes processing circuitry 221 and network interface 223. The processing circuitry may be a processor, application specific integrated circuit (ASIC), field programmable gate array (FPGA), or any suitable processing circuitry (in some embodiments, programmed with executable code) for carrying out the functionality described with reference to the security device 207. The network interface 223 may be any suitable network interface card (NIC) or other programming circuitry, which may be co-packaged with the processing circuitry 221, for receiving and forwarding traffic flows over one or more network paths.

The API server 225 provides an interface for remote procedure calls from the security device 207. The API server 225 may direct messages between any of the security device 207, the certificate authority 227, the database 229, and the intelligence server 217. In some embodiments, the security device 207 may bypass the API server 225 and connect directly to any of the other servers (e.g., 217 and/or 227) or databases (e.g., 229) in FIG. 2.

In some embodiments, the certificate authority 227 generates certificates for securing communications from the security device 207. For example, the certificates may be generated in response to an API call from the security device 207 to the API server 225, which may occur at the startup of the security device, in order to establish a new tunnel connection, or at any suitable time. In some embodiments, the certificate authority generates Secure Sockets Layer (SSL) certificates, but it should be appreciated that any suitable protocol, security parameter, or credential for securing security device 207 communications may be used.

In some embodiments, the database 229 holds client configuration information, which may indicate the state of the security device 207, any of the network paths established from the security device 207, relay servers used by the security device 207, or any other suitable configuration information. The database may be any suitable data store including a key-value store, a relational database, or any other suitable data store.

In some embodiments, the intelligence server 117 stores routing information (e.g. numeric network addresses and/or security parameters) for the security device 207 to use in selectively routing traffic. The routing information may be transmitted to the security device 207 at any suitable interval, when routing information is updated, and/or at any other suitable time. In some embodiments, the intelligence server 217 collects routing information for selecting network paths for routing traffic. For example, the intelligence server 217 may store network names (e.g., domain names) or network addresses (e.g., IP addresses) that are associated with network paths. For example, the intelligence server 217 may maintain lists of domain names such as a first list of domains associated with traffic to be routed directly to the destination over the Internet 211 without using security parameters or a second list of domains associated with domains to be routed over the premium VPN 241, as discussed in detail below.

In some embodiments, the intelligence server 217 provides load balancing by assigning the security device 207 to one of multiple relay servers for each set of security parameters. Load balancing may occur, for example, as was discussed with reference to intelligence server 117 and relay servers 119a and 119b.

The naming server 233, in response to requests, provides at least one numeric network address that corresponds to a network name in the request. In some embodiments, the security device 207 intercepts a message requesting a computing device provide a numeric network address that corresponds to a network name and edits the message to redirect the message to the naming server 233 to request that the naming server 233 provide the numeric network address. In some such embodiments, the intercepted message is a Domain Name Service (DNS) request (including a secure version of DNS, such as DNSSEC, or other suitable versions of DNS) that was transmitted to a first DNS server for which an address is specified in the DNS request. The DNS server may be a server of the ISP for the premises 101. When the security device 207 identifies the DNS request in traffic transmitted by the network of the premises 101, the security device may edit the DNS request to instead direct the request to a different server, specifically naming server 233. In some such embodiments, the source address of the DNS request is not edited by the security device 207, which ensures that the naming server 233 can readily return a response to the security device 207 configured to receive traffic destined for the network of the premises 101.

In some embodiments, the naming server 233 may be used to enforce network policies, such as parental blocking. For example, the naming server 233 may provide information categorizing content associated with a requested network name. In some embodiments, the naming server 233 may enforce parental blocking by not transmitting numeric network identifiers for domains that are blocked by parental filtering. In further embodiments, the naming server 233 may reply to the request with a numeric network address corresponding to a webpage indicating that the requested content is blocked. This may cause a user device requesting a blocked website domain name to be redirected to a website indicating that the requested domain was blocked.

In the example of FIG. 2, the security device 207 may selectively route traffic flows that travel through an access point (e.g. 105) of a premises network from a user devices (e.g., 103a-b) along one or more network paths including the Internet 211, and VPNs 235, 237, 239, and 241. In such embodiments, the traffic flows will be selectively routed over different network paths with different security parameters for each network. Routing the traffic over paths having different security parameters may include, in some embodiments, transmitting the traffic via different tunnels having different security parameters such as encryption, compression and different latencies.

The security device routes some traffic flows over the Internet 211 to the destination server 213. In some embodiments, the naming server 233 may indicate that a requested domain is configured to reject traffic received via a VPN, or provides a service (e.g., streaming media) for which providers often reject traffic received via a VPN. In such a case, the security device 207 may respond to the blocking or potential blocking by selecting to route a traffic flow to the server 213 over the Internet 211 without applying additional security parameters and, thus, rather than using any of the VPNs 235-241.

The VPNs 235-241 may provide different levels of security or other service, which may be chosen for different traffic flows based on a variety of factors described herein.

In some embodiments, the unencrypted VPN 235 provides for transmitting traffic flows to a relay server without encrypting the traffic. In such embodiments, the traffic may be vulnerable to inspection, but the unencrypted VPN 235 will not add substantially to the latency of the traffic. In further embodiments, the security device 207 may route user traffic over the unencrypted VPN 235 in response to determining that the traffic is addressed to a destination that accepts VPN traffic and/or is associated with an application (e.g., a multiplayer game) that exhibits a low ratio of the value of encryption to the cost of applying encryption. The cost of applying encryption may be measured in terms of an impact on application performance. For example, encrypting high volumes of traffic may cause performance degradation in certain applications and increase latency. The value of encrypting traffic may be determined based on the sensitivity or perceived sensitivity of the information in the traffic to the owner or occupier of the premises 101, and/or to the user or owner of devices 103. For example, applications may be classified based on categorizations of the application. Financial and medical information may be considered to have a high value of encryption, since many users consider this information highly personal and confidential, and owners or occupiers of a premises may be under strict legal obligations to maintains privacy, which may justify using encryption to maintain privacy. Peer-to-peer video gaming, on the other hand, may be considered to have low values of encryption, because it may generally be the case that data for such video games includes limited or no sensitive information. Other types of data may be similarly ranked, and applications, web sites, web services, or other communicators of network traffic may be ranked based on the type(s) of information they communicate. When a traffic flow is to be sent from or to an application, web site, web service, etc., a determination of whether to use encryption may be made based on whether to

[symbol]

If encryption is to be used, then the security device 207 may additionally determine whether compression is to be used. In some embodiments, the compressed VPN 237 and the uncompressed VPN 239 both handle encrypted traffic. The security device 207 may decide whether to compress a traffic flow based on a variety of factors, including an entropy score for traffic of the traffic flow.

An entropy score may be indicative of an entropy of information in the traffic. Entropy may relate to a variability of the traffic. Entropy may suggest a degree of benefit that may be realized from compressing the traffic, where the benefit may be expressed as an amount of bandwidth that is saved from the compression, by reducing the amount of data to be transmitted. If data is not very variable and includes only text, such traffic has a low degree of entropy. The data would (overall) shrink more when compressed, and thus may benefit from compression. If data is very variable and includes a lot of images or other encoded information, the traffic may have high entropy. The data may not shrink much when compressed, and may not benefit from compression.

In some embodiments, the entropy score may be a qualitative determination/categorization (e.g., using the categories of high or low), while in other embodiments the entropy may be determined as a numeric score. An entropy score may be computed based on a variety of factors that may generally characterize the types of data expected to be communicated in a traffic flow. Such factors may include the networking protocol used to communicate the traffic flow, the port number to which the traffic flow is being transmitted, or any other suitable characteristic of the traffic flow.

If both compression and encryption is to be used, another factor that may be considered by security device 207 is the speed by which the data is to be communicated. In some embodiments, a premium VPN 241 may be used to route premium traffic to suitable sources, using encryption and compression, and also having high bandwidth, shorter traffic routing during the VPN (e.g., shorter hops through the Internet 211), shorter traffic routing between the VPN and the destination (e.g., a termination point that is geographically or network-topographically close to many destinations of traffic sent via the premium VPN, such as in a co-location center with a destination or in the same cloud computing network as some destinations), and/or network addresses that are less likely to be blocked by destinations (e.g., uses an elastic IP address). In some embodiments, the premium VPN 241 may be more financially costly to utilize than other network paths and/or provide performance improvements, due to high monetary cost of transmitting messages by the premium VPN 241. The security device 207 may identify traffic that users desire to transmit quickly and securely, and prioritize that traffic for the premium VPN 241. Like with encryption or compression, different applications, web services, web sites, etc. may communicate information that users would identify as having different values for faster transmission. A ranking may be identified for each such application, web service, web site, etc. and when data is to be transmitted to a destination associated with such an application, web service, web site, etc. the premium VPN 241 may be selected.

Each of the VPNs 235, 237, 239, and 241 may connect the security device 207 to a respective relay server pool 243a-c or 245. Each of the relay server pools 243a-c and 245 may be configured to forward traffic to and from the security device according to respective security and networking protocols. Each relay server pool may contain one or more relay servers, for example as discussed with reference to 119a-b of FIG. 1. In some embodiments, relay server pools may contain multiple relay servers distributed over a geographic area or a content distribution network (CDN).

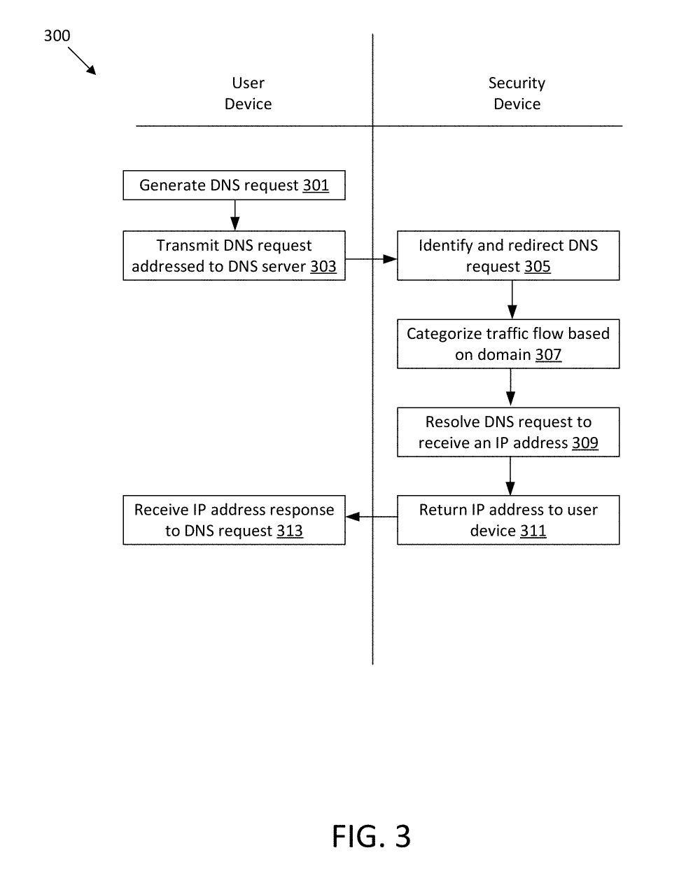

FIG. 3 shows an illustrative process 300 for capturing a DNS request, in accordance with some embodiments of the technology described herein. The process 300 may be executed by a user device (e.g., 103a-b of FIG. 1) and a security device (e.g., 107 or 207 of FIGS. 1-2). It should be appreciated that the embodiment of FIG. 3 is described with reference to DNS requests by way of illustration and is not meant to be limiting to DNS requests. The methods described with reference to FIG. 3 ay be implemented using any suitable protocol for resolving naming requests for a network resource.

The process 300 begins at act 301, in which the user device (e.g., 103a) generates a DNS request. For example, the DNS request may be generated in response to a user specifying a desired domain (e.g., “www.website.com”) in a web browser. The DNS request may be a request for a numeric network identifier corresponding to the domain name, such as an IP address (e.g., numeric address in accordance with Internet Protocol version 4 or version 6).

At act 303, the DNS request is transmitted by the user device to a DNS server. The DNS server may be configured to be a default DNS server for the device or specified as part of a network or device configuration. The default DNS server may be a DNS server operated by an ISP for the premises 101, or other DNS server identified to the network of the premises 101 during, for example, a configuration of the network for the premises 101 by the ISP network, such as during a Dynamic Host Configuration Protocol (DHCP) process.

At act 305, the security device identifies the DNS request in network traffic being transmitted from the network for the premises 101 and redirects the DNS request. In some embodiments, the security device may intercept and inspect datagrams being transmitted from the network of the premises 101, as part of securing traffic flows, and as part of that process may inspect datagrams to identify DNS requests. In further embodiments, that security device may inspect headers associated with the request to determine that the request is addressed to a DNS server and likely to be a DNS request.

At act 307, the security device categorizes the traffic flow based on the domain associated with the DNS request. In some embodiments, the security device categorizes the domain by forwarding the DNS request without performing categorization on the security device. In further embodiments, the categorization is provided by a naming server (e.g. 233) in response to the DNS request being redirected to the naming server.

At act 309 (which may be implemented together with act 307, in some embodiments), the security device resolves the DNS request. The security device may cache previous DNS replies or transmit the DNS request to a naming server (e.g. 233). In some embodiments, the naming server, in response to requests, provides at least one numeric network address that corresponds to a network name in the request. In some embodiments, the security device intercepts a message requesting a computing device (e.g., a DNS server) provide a numeric network address that corresponds to a network name and edits the message to redirect the message to the naming server to request that the naming server provide the numeric network address. In further embodiments, the security device edits the request to replace an IP address of a DNS server with the IP address of the naming server, which is configured to resolve DNS requests. In some embodiments, the source of the message is not edited by the security device, which ensures that the naming server can readily return a response to the security device configured to receive traffic destined for the premises network. In some embodiments, the reply received from the naming server is identical to the reply that would be received from the originally addressed naming server.

In some embodiments, the naming server may be used to enforce network policies, such as parental blocking. For example, the naming server may provide information categorizing content associated with a requested network name. In some embodiments, the naming server may enforce parental blocking by not transmitting numeric network identifiers for domains that are blocked by parental filtering. In further embodiments, the naming server may reply to the request with a numeric network address corresponding to a webpage indicating that the requested content is blocked. This may cause a user device requesting a blocked website domain name to be redirected to a website indicating that the requested domain was blocked.

At act 311, the security device returns the numeric network address received in response to the DNS request to the user device. In some embodiments, the security device may store an association between the requested domain and the IP address received in reply in order to associate future traffic flows with a domain. At act 313, the user device receives the IP address in response to the DNS request. In some embodiments, it is not revealed to the user device that the DNS request was redirected.

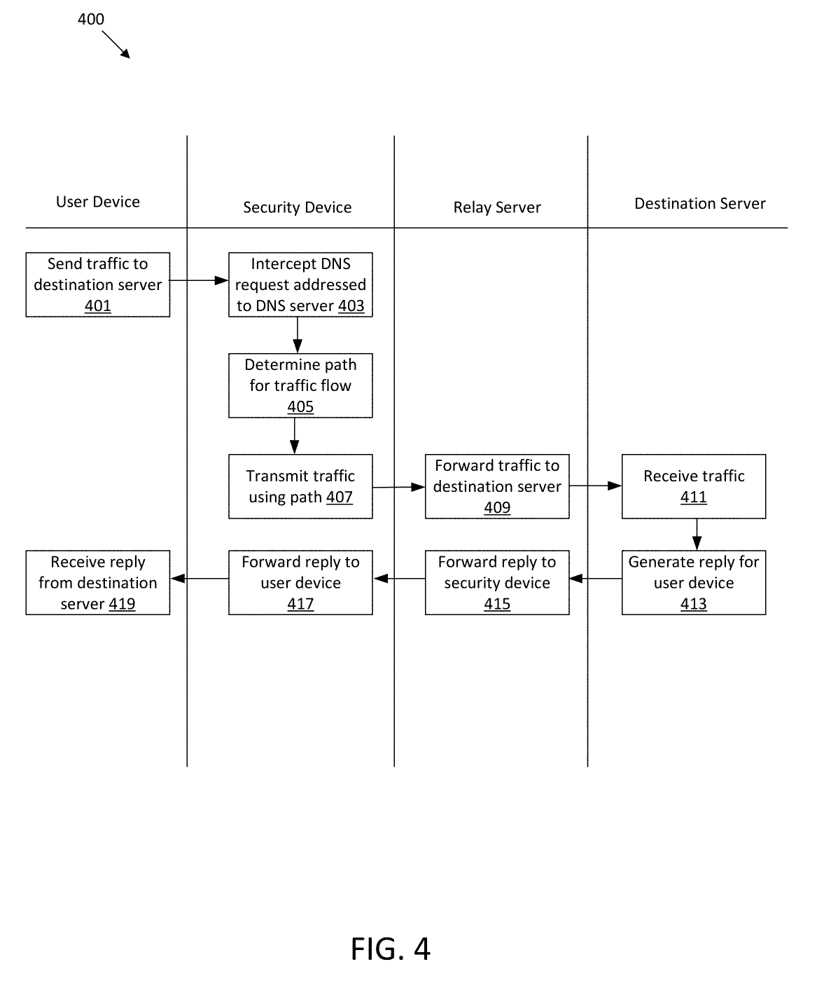

FIG. 4 shows an illustrative process 400 for routing network traffic between a user device and destination server along a VPN pathway, in accordance with some embodiments of the technology described herein. The process 400 may be implemented by a user device (e.g., 103a-b), a security device (e.g., 107 and/or 207 of FIGS. 1-2), a relay server (e.g. 119a-b, 243a-c, and/or 245 of FIGS. 1-2), and a destination server (e.g. e.g. 113a-b and/or 213 of FIGS. 1-2). The process allows the security device to selectively route traffic over one of multiple network paths.

The process 400 begins at act 401, in which the user device sends traffic to the destination server. The traffic from the user device may be any network traffic. In some embodiments, the security device is positioned on a local network to capture some or all of the network traffic, and, at act 403, the security device intercepts a DNS request associated with the traffic flow. Intercepting DNS requests is discussed with reference to FIG. 3.

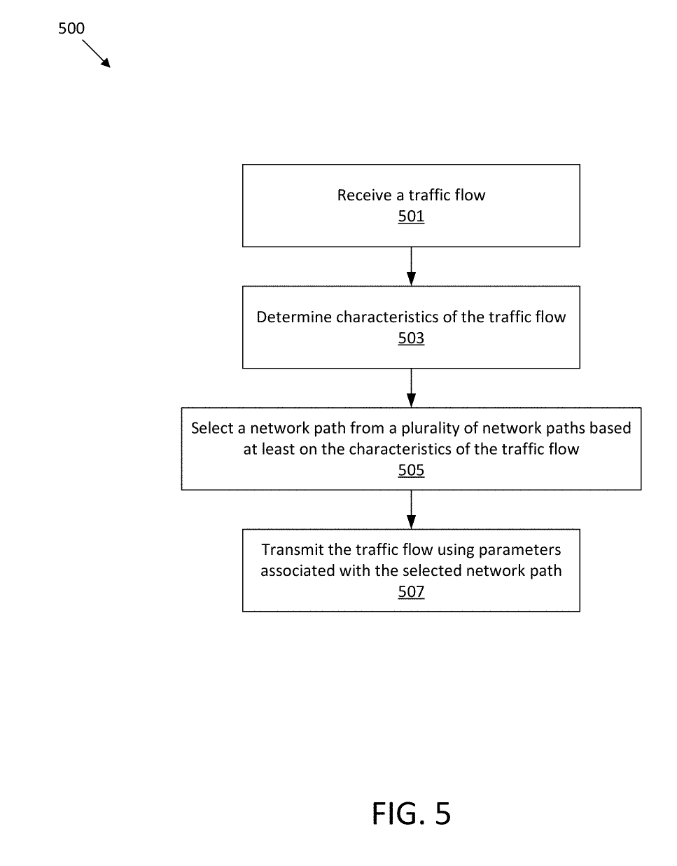

At act 405, the security device determines a path for the traffic flow. The path may be selected based on a domain associated with the DNS request and the future traffic flow. In some embodiments, the path for the traffic flow may be selected based on the domain. In some embodiments, the path for the traffic flow may be selected based on additional characteristics of the traffic flow, such as the protocol, port, application, an encryption value to cost ratio, and/or an entropy score. In some embodiments, the security device may store lists of domains associated with traffic to transmit on one or more of the network paths. Determining a path for a traffic flow is discussed with reference to at least FIGS. 5-8.

The security device may select one of multiple available paths (e.g., each of the paths discussed with reference to FIG. 2). At act 407, the security device transmits the traffic over the selected path. The security device applies the necessary security parameters, including encryption and/or compression, prior to transmitting the traffic on the path. At act 409, the traffic is received at a relay server, which may be configured to receive traffic over a tunnel connection from the security device, and forwarded to the destination server. At 411, the destination server receives the user traffic and, at act 413, generates a reply responsive to the traffic. The destination server transmits the reply to the relay server since the destination server received the traffic from the relay server. At act 415, the relay server forwards the reply to the security device, which forwards the reply to the user device at act 417. At act 419, the user device receives the reply from the destination server without any indication that the intervening forwarding by the security device occurred.

FIG. 5 shows an illustrative process for selecting a network path for routing user traffic, in accordance with some embodiments of the technology described herein. The process 500 may be implemented by a security device (e.g. 107 or 207 of FIGS. 1-2) to selectively route traffic from a user device (e.g. 103 of FIG. 1).

The process 500 begins at act 501, when the security device receives a traffic flow. The traffic generated by a user device may be addressed to a destination server an intercepted by the security device. The received traffic flow may be any network traffic. In some embodiments, the security device is positioned on a local network to capture some or all of the network traffic.

At act 503, the security device determines characteristics of the traffic flow. In some embodiments, the security device captures a request to identify a numeric network address (e.g., IP address) based on a network name (e.g., a domain name), and the characteristics include the domain name and/or IP address. In some embodiments, the security device may determine whether the traffic is addressed to a destination that accepts VPN traffic. In some embodiments, the security device may determine an encryption value to cost ratio for the traffic. The cost of applying encryption may be measured in terms of an impact on application performance. For example, encrypting high volumes of traffic may cause performance degradation in certain applications and increase latency. The value of encrypting traffic may be determined based on the sensitivity of the information in the traffic. For example, applications may be classified based on categorizations of the application. In further implementations, an entropy score is computed to be indicative of the entropy of the information in the traffic and, therefore, the benefits that may be realized from compressing the traffic. In some embodiments, the entropy score may be any suitable qualitative determination/categorization (e.g., using the categories of high or low) or numerical score. The entropy score may be computed based on at least the networking protocol used by an application, the port number used by an application, or any other suitable characteristic of the traffic flow.

At act 505, the security device selects a network path from a plurality of network paths based at least on the characteristics of the traffic flow. In some embodiments, traffic addressed to destinations that are configured to reject VPN traffic is transmitted over a public network without additional security parameters. Traffic may be routed on a VPN selected from multiple VPNs that may implement security parameters including compression and levels of encryption, for example as was discussed with reference to the VPNs of FIG. 2. At act 507, the security device transmits the traffic flow using the security parameters associated with the selected network path. The security device may apply the encryption, compression, or other parameters to the traffic in order to maintain a secure connection with a relay server.

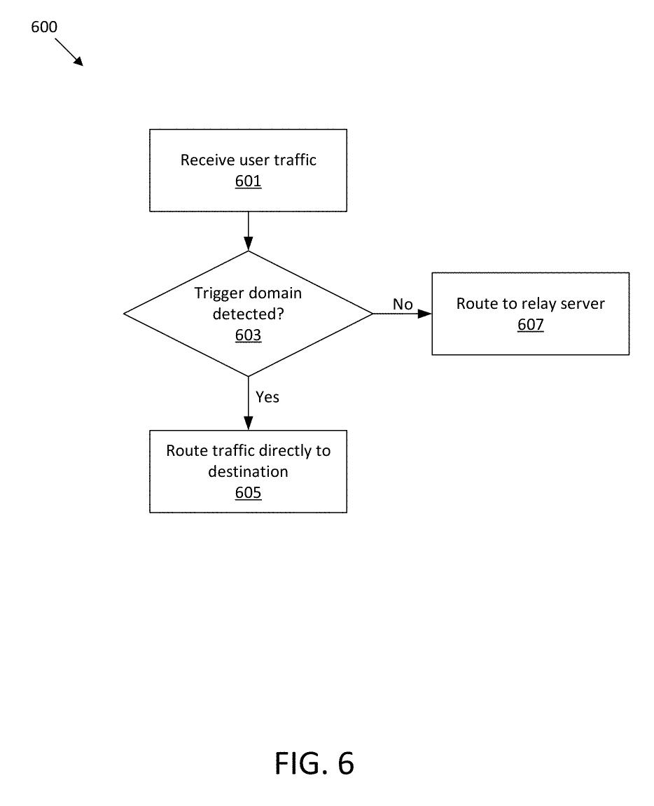

FIG. 6 shows an illustrative process 600 for selecting a network path for routing user traffic, in accordance with some embodiments of the technology described herein. The process 600 may be implemented by a security device (e.g. 107 or 207 of FIGS. 1-2).

At act 601, the security device receives traffic from a user device. The traffic may be any network traffic including a DNS request. At act 603, the security device determines whether a trigger domain is detected in the traffic. In some embodiments, a trigger domain corresponds to a destination servers that are configured to reject VPN traffic. In some embodiments, trigger domains may correspond to domain that do not require additional security or that require low latency. In some embodiments, the trigger domain may be contained in a received DNS request. In some embodiments, the traffic may not include a domain name, and the security device stores an association between numeric network addresses in the traffic and the corresponding domain.

In some embodiments, a list of trigger domains may be maintained by an intelligence server. An administrator of the intelligence server may, from time to time, add or remove domains from the list of trigger domains. The domains may be associated with applications, web sites, web services, or other systems that communicate traffic over the Internet and for which traffic should not be communicated via a tunnel. The list of domains may include domains that are associated with web services that block traffic communicated via a VPN, such as streaming media services. Though, it should be appreciated that the list of trigger domains is not so limited, and that an administrator may add domains for which VPNs or tunnels are not to be used for other reasons. The domains may be added by specifying, in a list, a domain name or host name, or other name associated with the domain. The security device may then request and/or receive the list from the intelligence server periodically or occasionally, at any suitable interval or in response to any suitable condition, as embodiments are not limited in this respect.

Such a list maintained by an administrator may be provided to each of multiple different security devices, each associated with a different premises. In some embodiments, each premises may also create its own list of trigger domains, which may replace or supplement the list maintained by the administrator. Such a list may be maintained by the security device or by the intelligence server, and may be created by user input via any suitable user interface from any suitable device. Additionally or alternatively, in some embodiments, each premises may be flagged as being of a particular type, such as a residential, commercial, or industrial premises, or different types of commercial premises. In some such cases, different trigger domains may be associated with different trigger domains. A security device may be configured with a type of the premises with which it is associated, and may request from the intelligence server a list of trigger domains corresponding to the type of premises.

In block 603, the security device may determine whether a domain for a new traffic flow is on the list of trigger domains.

At act 605, when a trigger domain is detected, the security device routes traffic directly to the destination. In some embodiments, traffic routed directly is sent over a public network, including the internet, and/or without applying additional security parameters. At act 607, when a trigger domain is not detected, the security device routes traffic to a relay server by way of a tunnel (e.g., VPN).

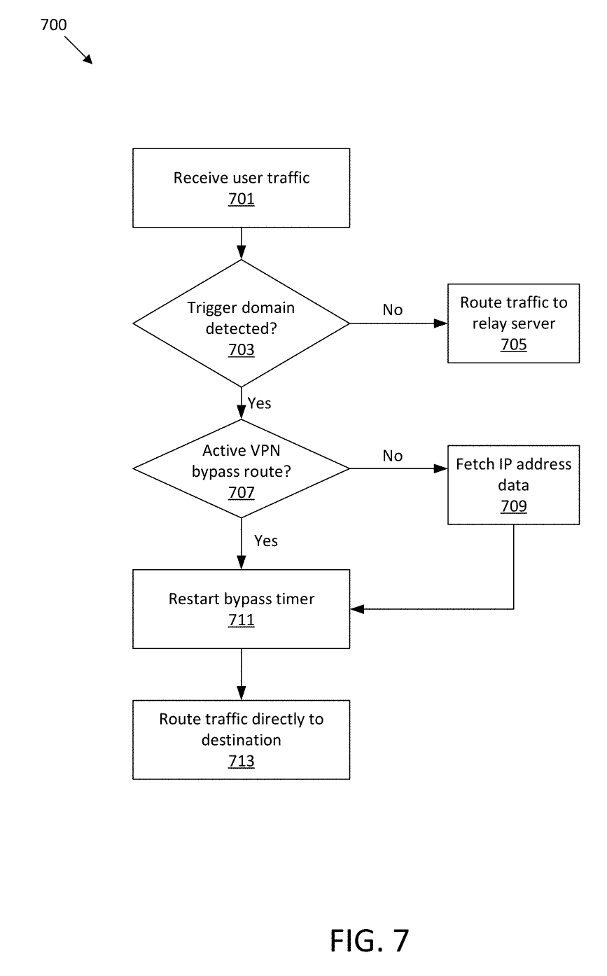

FIG. 7 shows an illustrative process 700 for selecting a network path for routing user traffic, in accordance with some embodiments of the technology described herein. The process 700 may be implemented by a security device (e.g., 107 or 207 of FIGS. 1-2) and allows the security device to bypass VPNs for routing traffic directly to the destination.

The process 700 begins at act 701. The security device receives user traffic, determines whether a trigger domain is detected at act 703, and routes traffic to a relay server when no trigger domain is detected. Receiving traffic, detecting a trigger domain, and routing traffic to a relay server may be implemented in some embodiments as discussed with reference to FIG. 6 above.

At act 707, when a trigger domain is detected, the security device determines whether any routes for bypassing the VPN are currently active. In some embodiments, when it is determined that a traffic flow is to be sent directly via the Internet without use of a tunnel, a record of this “bypass” may be created, that indicates that future traffic that is to be communicated with the destination of that traffic flow should also be sent directly via the Internet. This may have the benefit of avoiding or reducing redundancy of successive determinations being made that traffic is to be sent directly via the Internet, rather than via a tunnel. This may also help with domains that are associated with a large numbers of different subdomains or a large number of different IP addresses, such as media streaming services implemented via Content Distribution Networks (CDNs) or other forms of cloud computing services. In such cases, there may be slight variations in the full domain (including subdomain) or in IP addresses to which traffic flows are directed. These slight variations could create redundancy in determining whether to communicate traffic via a direct path through the Internet, or via a tunnel. Creating a list of entries for destinations for which a direct path via the Internet is to be used—referred to herein as a bypass list—can help reduce that redundancy, by allowing for quickly checking whether such a determination has already been made for a traffic flow. Each entry in the list may specify a domain name and/or other characteristics of a traffic flow. In block 707, characteristics of a new traffic flow may be compared to the bypass list, to determine whether a determination has already been made.

If no bypass routes are active, then in act 709, the security device may query a name server (e.g., a DNS server, such as name server 233 of FIG. 2) and/or an intelligence server (e.g. 117 or 217 of FIGS. 1-2) for an updated list of numeric network addresses associated with the trigger domain. The numeric network addresses may then be used to create a path to the trigger domain that does not involve a tunnel.

At act 711, the security device restarts a timer for a bypass entry. If a bypass entry had not been previously created, the bypass entry may be created in block 711, which may include adding an entry specifying one or more characteristics of the traffic flow, such as a domain. The timer may aid in ensuring (in some embodiments) that routes used to bypass the tunnels do not remain permanently open, as the need to use the bypass routes for any given domain may vary from time to time. For example, trigger domains may be removed from the list from time to time, if settings of those servers change over time. The timer may allow for the security device to close a bypass route after a time, which is when the timer expires. In the case that a bypass route was active, the timer may be restarted if a new traffic flow to the destination is being created, to prevent an active bypass route from being removed too early or before the security device stops using that bypass. In some embodiments, a timer may prevent content distribution networks and other hosting platforms from publicly receiving traffic that should have been sent over the VPN since the platform host trigger and non-trigger domains.

At act 713, the traffic is routed directly to the destination using the bypass route.

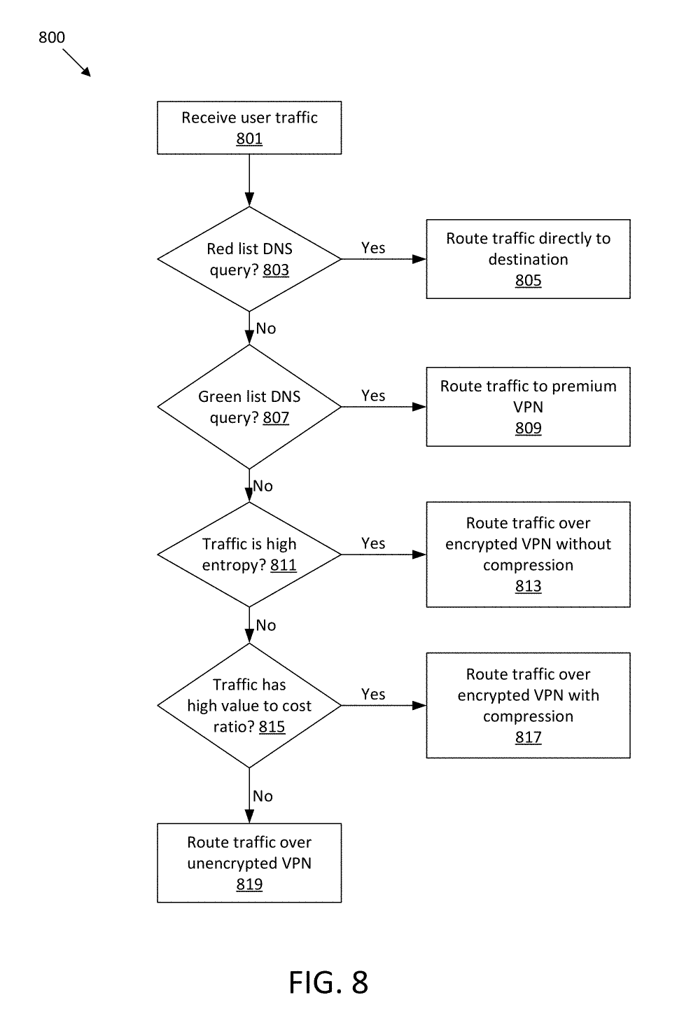

FIG. 8 shows an illustrative process 800 for selecting a network path for routing user traffic, in accordance with some embodiments of the technology described herein. The process 800 may be implemented by a security device (e.g., 107 or 207 of FIGS. 1-2). The process allows the device to selectively route traffic over multiple network paths based on characteristics of the traffic.

The process 800 begins, at act 801, where the security device receives user traffic. At step 803, the security device determines whether the received traffic corresponds to a DNS query for a first list of domains, which may be referred to as a “red” list. In some embodiments, “red” list domains include domains for which traffic should be routed over public networks, such as the Internet, without using a tunnel. Some such red list domains may be configured to reject VPN traffic, or may be flagged as being destinations for which tunnels should not be used for other reasons. In some embodiments, as discussed above in connection with FIG. 6 and a list of trigger domains, the red list is maintained by an intelligence server (e.g. 117 or 217 of FIGS. 1-2) and provided to the security device. At act 805, when a “red” list domain is detected, the traffic is routed directly to the destination, for example as was discussed with respect to FIGS. 6-7.

At act 807, when a “red” list DNS query is not detected, the security device determines whether the DNS query corresponds to a second list of domains, which may be referred to as a “green” list. In some embodiments, a “green” list domain is a domain that may receive traffic over a premium VPN. Such “premium” traffic was discussed above in connection with FIG. 2. The “green” list may be configured and created similarly to the “red” list. For example, the “green” list may be created or maintained using any of the approaches for creating and maintaining a list of trigger domains discussed above in connection with FIG. 6. At step 809, a traffic flow that is determined to correspond to one of the entries in the green list is routed to the destination using a premium VPN in response to detecting the green list domain.

The determinations of block 803, 807 may be made by the security device based on DNS requests issued before communication between a device (e.g., device 103 of FIG. 1) and a destination starts. Resolving a domain name to a numeric address (e.g., IP address), using a DNS request or other name resolution protocol, may allow for transmitting messages between the device and the destination, because the transmission of messages according to some protocols relies on transmitting messages using numeric addresses rather than domain names. Some determinations regarding traffic flows may be made based on the identity of the destination, which may be determined from the DNS requests that are sent before a traffic flow begins. These determinations, and the characteristics determined from them, may drive the decisions in blocks 803, 807.

If a network path cannot be identified for a traffic flow from the domain name, though, determinations in blocks 811, 815 may be made based on messages that start the communications between the device and the destination. Such messages may include messages according to a network-layer protocol, such as handshake messages establishing a network-layer session. Such handshake messages may include TCP SYN, SYNACK, or ACK messages that establish a TCP connection. When such handshake messages are identified in a header of datagrams intercepted by the security device, information like the destination port for a traffic flow may be identified, which may be used in some embodiments to characterize traffic flows and determine over which tunnel to transmit a traffic flow. Other messages starting a communication may also be analyzed by the security device to determine how to route a traffic flow. For example, rather than network-layer messages, application-layer protocol messages may be analyzed in some embodiments, such as messages that are exchanged according to an application-layer protocol and that initiate an exchange of communications. For example, the Hypertext Transfer Protocol (HTTP) may include transmitting an HTTP GO or HTTP POST message to request transmission of content, or other HTTP message requesting transmission of content. Such a message, when detected in a payload of a datagram intercepted by the security device, may be used by the security device to identify an application protocol that is to be used to exchange data in a traffic flow. The application protocol may be used to characterize traffic, and may be used by the security device to select a network path.

At act 811, the security device determines based on one or more characteristics of the traffic whether the traffic has a high entropy score. As discussed above in connection with FIG. 2, the entropy score is indicative of the entropy of the information in the traffic and, therefore, the benefits that may be realized from compressing the traffic. In some embodiments, the entropy score may be any suitable qualitative determination/categorization (e.g., using the categories of high or low) or numeric score. Rather than being calculated based on characteristics of traffic data itself, in some embodiments, the entropy score may be computed based on at least the networking protocol used by an application transmitting the traffic flow, the port number used by the traffic flow, or other suitable characteristics of the traffic flow. The security device may maintain known relationships between application/port and entropy level, such that determining the entropy level may include determining an entry in a lookup table corresponding to the application/port identified for the traffic flow. Entropy scores are discussed in more detail with reference to FIG. 2.

If it is determined that the traffic is high entropy, then at act 813, the security device selects, for transmission of traffic for the traffic flow, a VPN that transmits a traffic flow using encryption but not using compression (e.g., VPN 239 of FIG. 2).

If, however, the security device determines in act 811 that the data does not have high entropy (including if it has low entropy), then at act 815, the security device determines whether the traffic has a high encryption-value-to-cost ratio. In some embodiments, the security device may determine that the traffic is associated with an application (e.g., a multiplayer game) that exhibits a low ratio of the value of encryption to the cost of applying encryption. The cost of applying encryption may be measured in terms of an impact on application performance. For example, encrypting high volumes of traffic may cause performance degradation in certain applications and increase latency. The value of encrypting traffic may be determined based on the sensitivity of the information in the traffic. For example, applications may be classified based on categorizations of the application. Financial and medical information may be considered to have a high value of encryption, since the encryption protects user privacy. Peer-to-peer file sharing and gaming may be considered to have low values of encryption since the traffic reveals a limited amount of sensitive information. In some embodiments, the security device may maintain known relationships between application/port/protocol and entropy-cost ratio, such that determining the entropy level may include determining an entry in a lookup table corresponding to the application/port/protocol identified for the traffic flow. At act 817, in response to determining in act 815 that the traffic flow has an encryption-value-to-cost ratio that is high (and in response to determining in act 811 that the traffic flow has low entropy), the security device selects for the traffic flow a tunnel that uses by encryption and compression (e.g., VPN 237 of FIG. 2).

At act 819, the security device determines, in response to the determinations of acts 803, 807, 811, and 815 that the traffic that is not on the red list or green list, has low entropy, and has a low value-to-cost ratio for encryption, that the traffic is to be routed over an unencrypted VPN (e.g., VPN 235 of FIG. 2).

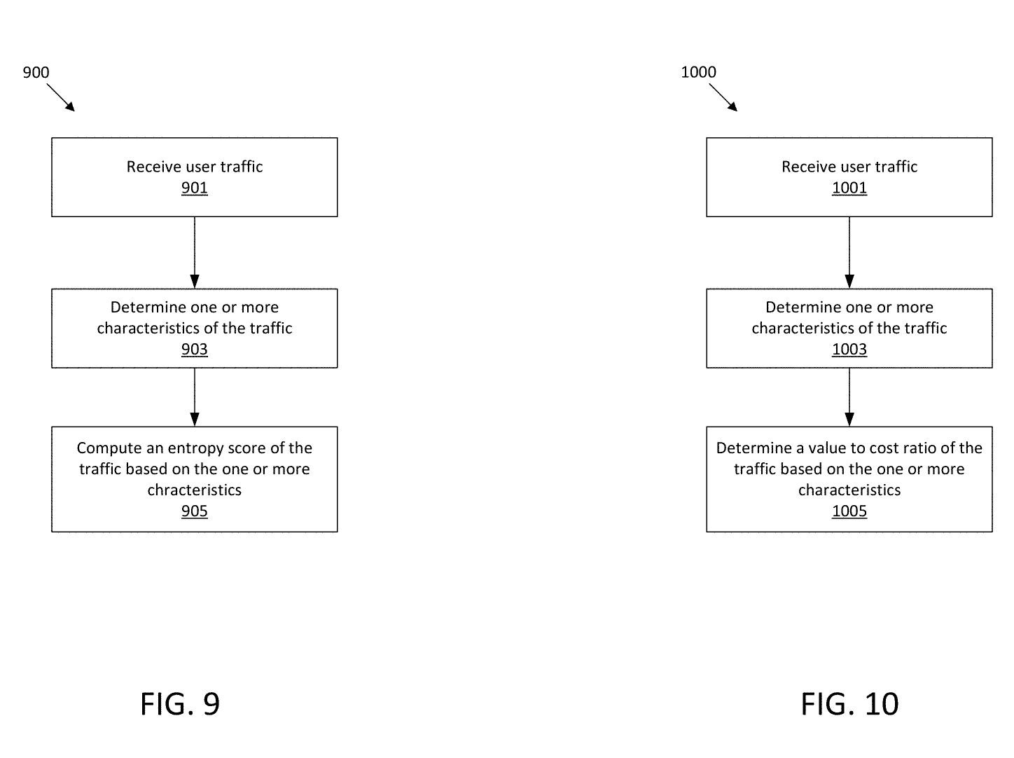

FIG. 9 shows an illustrative process 900 for computing an entropy score for network traffic, in accordance with some embodiments of the technology described herein. As should be appreciated from the foregoing, an entropy score characterizes traffic that is to be exchanged for a traffic flow and may be used to select a tunnel by which to communicate the traffic flow. However, at the time that the entropy score is used to select the tunnel, the traffic has not yet been communicated. As such, the traffic itself cannot be analyzed to determine an entropy score. The inventors have recognized and appreciated, however, that various characteristics of the traffic may be used to infer entropy of the traffic, and that a determination of entropy may be made in this manner.

The process 900 may be implemented using a security device (e.g., 107 or 207 of FIGS. 1-2). At act 901, the security device receives user traffic. At act 903, the security device determines one more characteristics of the traffic. The characteristics may include application that is used to send or receive traffic of the traffic flow, which may be indicative of a type of data that is communicated, including how confidential a user may consider the data to be; destination port for the traffic flow, which may suggest the application that is used for the data as many applications are configured to use a particular port as the destination port; or the network-layer protocol that is used to communicate the application data, such as whether TCP or the User Datagram Protocol (UDP) is used.

At step 905, the security device computes an entropy score of the traffic based on the one or more characteristics. Computing entropy scores is discussed above, including with reference to FIGS. 2 and 8. In some embodiments, the security device may maintain known relationships between application/port and entropy level, such that determining the entropy level may include determining an entry in a lookup table corresponding to the application/port identified for the traffic flow.

In other embodiments, a numeric score of entropy may be computed. The security device may use any suitable technique to determine the numeric score, as embodiments are not limited in this respect. For example, in some embodiments different applications or ports may be associated with different values or weights, and a score may be calculated by identifying the numeric value/weight for each attribute, then summing, multiplying, or otherwise combining numeric values for each of the attributes to determine an overall entropy score. The numeric score may then be compared to a threshold or otherwise analyzed to determine whether the score is high or low.

FIG. 10 shows an illustrative process 1000 for determining an encryption-value-to-cost ratio for network traffic, in accordance with some embodiments of the technology described herein. The process 1000 may be implemented using a security device (e.g., 107 or 207 of FIGS. 1-2). At act 1001, the security device receives user traffic. At act 1003, the security device determines one more characteristics of the traffic. The characteristics may include application that is used to send or receive traffic of the traffic flow, which may be indicative of a type of data that is communicated, including how confidential a user may consider the data to be; destination port for the traffic flow, which may suggest the application that is used for the data as many applications are configured to use a particular port as the destination port; or the network-layer protocol that is used to communicate the application data, such as whether TCP or the User Datagram Protocol (UDP) is used.

At step 1005, the security device computes an encryption value to cost ratio of the traffic based on the one or more characteristics. Computing value-to-cost scores is discussed above, including with reference to FIGS. 2 and 8. In some embodiments, the security device may maintain known relationships between application/port/protocol and entropy-cost ratio, such that determining the entropy level may include determining an entry in a lookup table corresponding to the application/port/protocol identified for the traffic flow. In other embodiments, a numeric score may be calculated, such as using weighting techniques described in connection with FIG. 9.

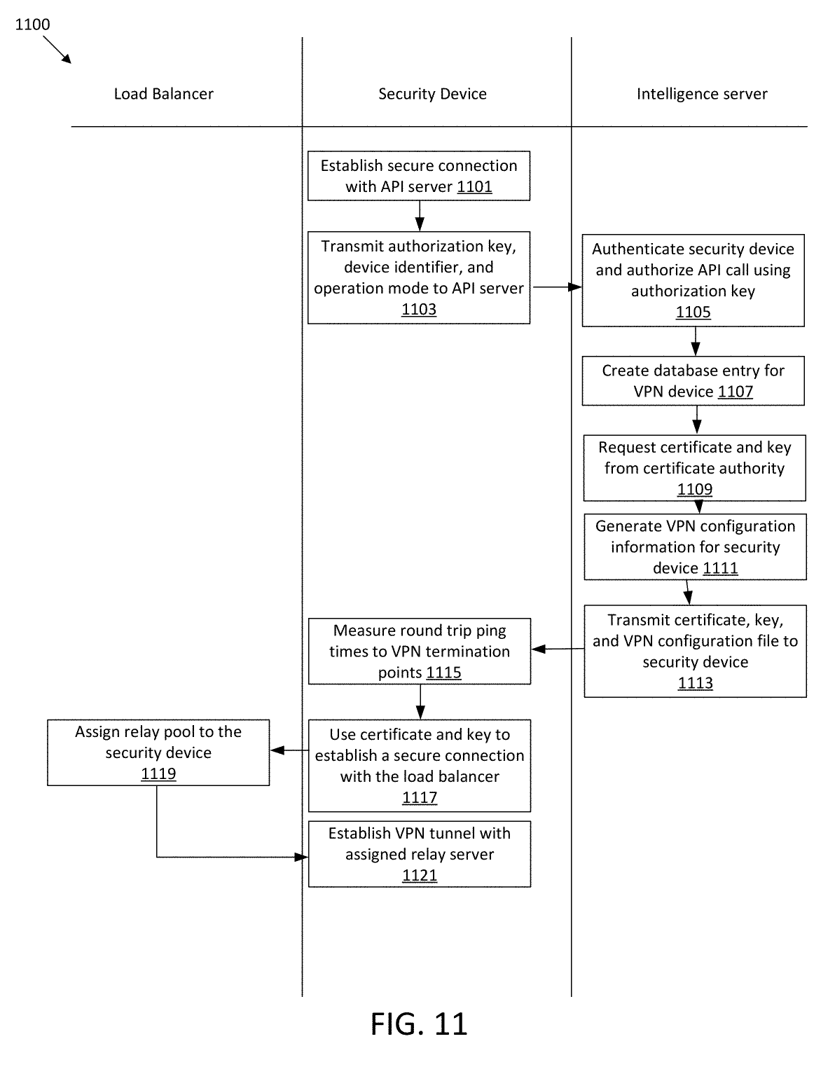

FIG. 11 shows an illustrative process 1100 for connecting a VPN device to a relay server acting as a virtual termination point (VTP), in accordance with some embodiments of the technology described herein. In the example of FIG. 11, the process 1100 is implemented by a load balancer, a security device (e.g., 107 or 207 of FIGS. 1-2), and an intelligence server (e.g., 117 or 217 of FIGS. 1-2). In some embodiments, the intelligence server may act as a load balancer. The intelligence server may include an API server to provide an interface for remote application calls from the security device.

The process 110 begins at act 1101, where the security device establishes a secure connection with an API server. The secure connection may be established with any suitable security credentials. At act 1103, the security device transmits at least an authorization key, a device identifier, and/or an operation mode for the device to the API server using the secure channel.

At act 1105, the intelligence server authenticates the security device based using the authorization key. In some embodiments, if the authorization key is valid, the security device may be allowed to make API calls to the intelligence server. At act 1107, once the authorization key is validated, the intelligence server creates a database entry to store the information received from the security device.

At act 1109, the intelligence server requests a certificate and key from the certificate authority 1109. In some embodiments, the certificate provides any security parameters suitable for establishing VPN or private tunnel connections. At act 1111, the intelligence server generates VPN configuration information to provide information regarding the available VPN networks and relay servers to the security device. At act 1113, the certificate, key, and VPN configuration information are transmitted to the security device.

In the exemplary embodiment of FIG. 11, at act 1115, the security device measures the round trip ping latencies measured by pinging available relay servers. In some embodiments, relay servers are assigned based on network proximity, which may be measured by ping latencies. At act 1117, the security device may use the certificate and key issued by the certificate authority to make a secure connection with a load balancer that assigns relay servers. In some embodiments, the load balancer may be implemented on one or more of the same servers as were described with reference to FIG. 2, such as the intelligence server, API server, and certificate authority. At act 1119, the load balancer assigns a relay pool to the security device for forwarding traffic sent according to corresponding security parameters. At act 1121, the security device establishes one or more VPN tunnels with the relay server assigned by the load balancer. The one or more VPN tunnels may be established using the VPN configuration information generated by the intelligence server in act 1111.

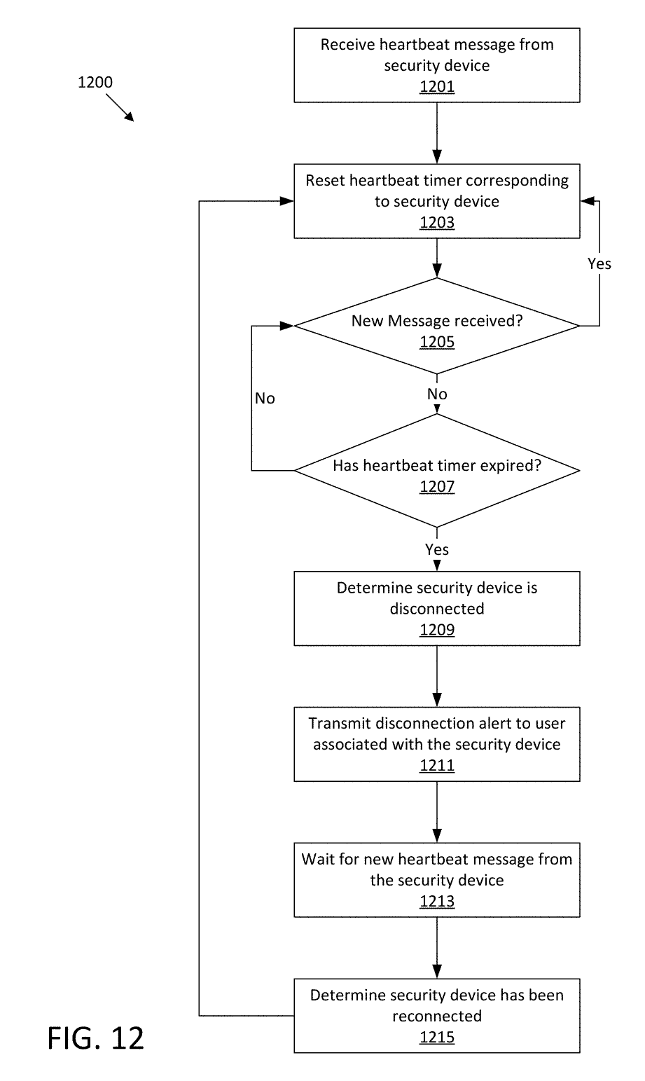

FIG. 12 shows an illustrative process for detecting the disconnection of a VPN device, in accordance with some embodiments of the technology described herein. In some embodiments, the security device may be configured to prevent user circumvention, such as a user of the premises 101 disconnecting the security device to avoid traffic. For example, a user may seek to disconnect the security device to circumvent parental filtering or compromise user security. The process 1200 detects such attempts by monitoring periodic heartbeat pings from the security device and alerts users to detected attempts to circumvent the security device. The process 1200 may be implemented using a security device and a monitoring server, which may be any suitable server (e.g. 117 or 217 of FIGS. 1-2). In some embodiments, the monitoring server is not on the same premises as the security device and communicates over any suitable wide area network.

At act 1201, the security device transmits a heartbeat message to the monitoring server. The heartbeat message may be any suitable message for identifying the security device to the monitoring server and indicating the security device is properly connected. At act 1203, the monitoring server resets a heartbeat timer corresponding the security device identified by the heartbeat message. At acts 1205 and 1207, the monitoring server checks whether a new heartbeat message has been received, prompting the heartbeat timer to be reset, before the heartbeat timer expires. At act 1209, after the expiration of the heartbeat timer, the monitoring server determines that the security device has been disconnected.

At act 1211, the monitoring server alerts the user the security device is disconnected, such as by transmissions of textual messages via email, text/Simple Messaging Service (SMS)/Multimedia Messaging Service (MMS), or other messaging systems. In some embodiments, the monitoring server may store associations between customer information and security device identification information.

At act 1213, the monitoring server waits to receive a new heartbeat message from the security device. In some embodiments, the monitoring server logs the time between heartbeat messages. In some embodiments, the monitoring server re-transmits the alert to the user after one or more time intervals without receiving a new heartbeat message. At act 1215, the monitoring server has received a new heartbeat message and determines that the security device has been reconnected. In some embodiments, relay servers may provide monitoring by monitoring traffic levels from the security device.

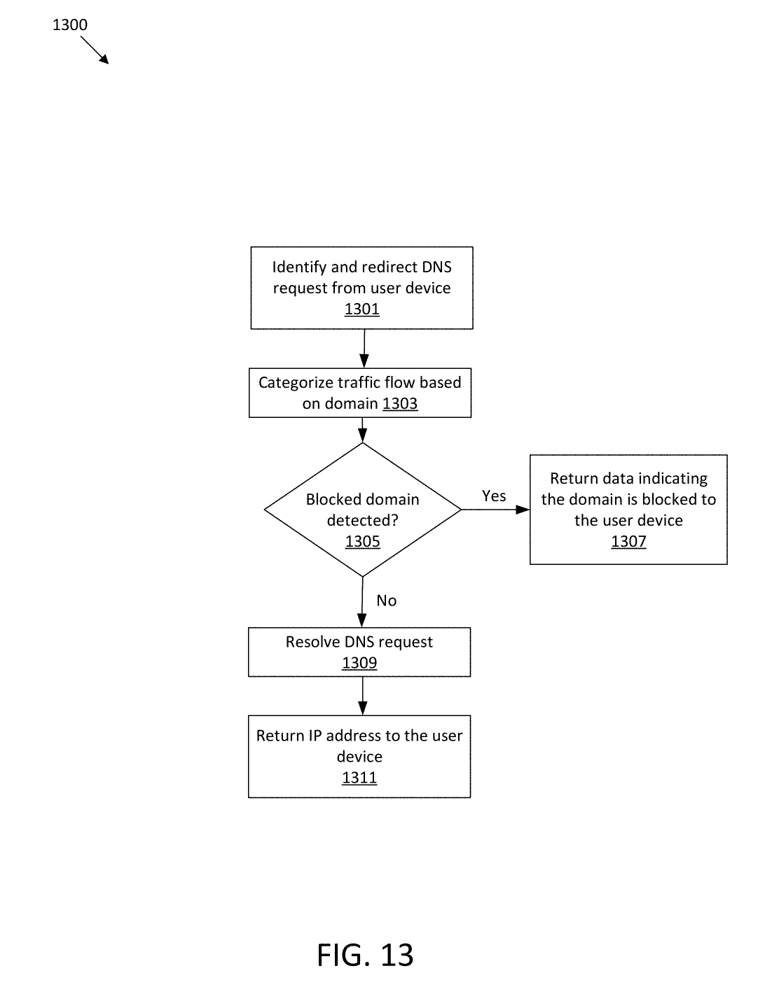

FIG. 13 shows an illustrative process 1300s for filtering content by capturing a DNS request, in accordance with some embodiments of the technology described herein. The process 1300 allows the security device to provide parental blocking. As was discussed with reference to FIG. 3, the security device and one or more naming servers (e.g. 233) may redirect request to resolve a network name to a numeric network address. The security device and/or a naming server may allow a parent or administrative user to mark certain domains as being blocked. At act 1305, the naming server may determine the DNS request of act 1301 corresponds to a blocked domain. In some embodiments, the naming server may enforce parental blocking by not transmitting numeric network identifiers for domains that are blocked by parental filtering. In further embodiments, the naming server may reply to the request with a numeric network address corresponding to a webpage indicating that the requested content is blocked at act 1307. This may cause a user device requesting a blocked website domain name to be redirected to a server that, in response to any request for web traffic (e.g., a request for any web page) returns web page having content indicating that the requested domain was blocked.

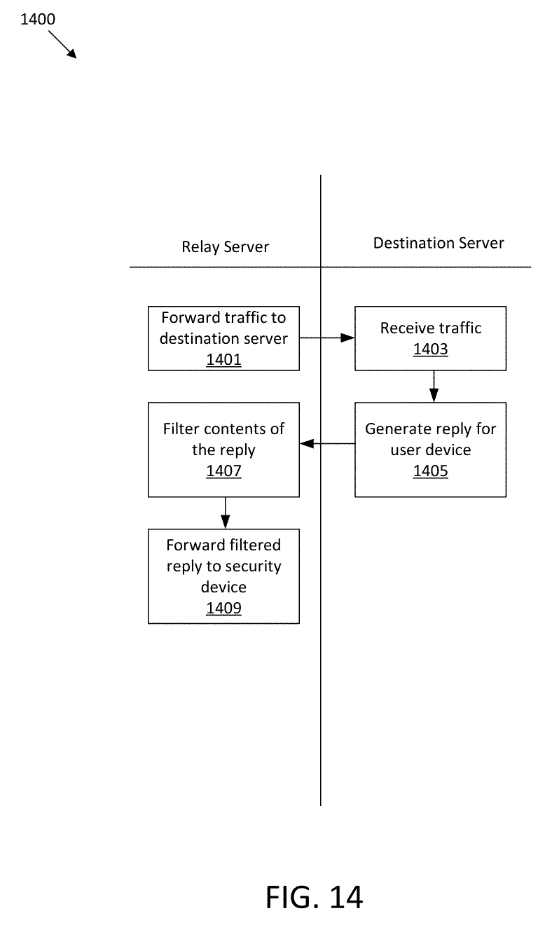

FIG. 14 shows an illustrative process for filtering content received through a VPN, in accordance with some embodiments of the technology described herein. As was discussed with reference to FIG. 4, in block 1401 the relay server may relay to a destination server traffic received via one or more tunnels. The destination server, in turn, may be configured to receive the requests for content in block 1403 and transmit an appropriate response, via the relay server, in block 1405. At act 1407, the relay server may filter the contents of the reply from the destination server. For example, the relay servers 119a-b may be configured to block advertising sent from the destination server to the user device, or block traffic associated with adult content, illicit content, content associated with known sources of malware (e.g., viruses), or other content. To block the content, in cases in which the reply content includes Hypertext Markup Language (HTML) of a web page, the relay server may simply edit the HTML to remove references to blocked content. The relay server may determine that the HTML references blocked content by examining URLs included in the web page, and determining whether the domains referenced in the URLs relate to known sources of blocked content, such as known servers that distribute advertisements, known servers that distribute adult content, etc. The determination may be made, in some embodiments, using a technique that is similar to that described in connection with FIG. 13, relating to blocked domains. After filtering the content, the reply from the destination server is forwarded by the relay server to the security device, to be sent to the source of the traffic flow (e.g., a device 103 of FIG. 1). While an example of blocking content by editing the HTML has been described, it should be appreciated that in some embodiments, rather than editing the HTML, the initial reply from the destination server including the HTML may be returned unedited, but the relay server may not relay any future requests relating to elements of the web page, such as requests for images, advertisements, etc. for blocked domains. Such other requests may be in the form of additional HTTP messages beyond the initial message, which the relay server may detect in the traffic flow and not relay, so as to block.

Techniques operating according to the principles described herein may be implemented in any suitable manner. Included in the discussion above are a series of flow charts showing the steps and acts of various processes that selectively route user traffic over multiple network paths with different security and/or encoding parameters. The processing and decision blocks of the flow charts above represent steps and acts that may be included in algorithms that carry out these various processes. Algorithms derived from these processes may be implemented as software integrated with and directing the operation of one or more single- or multi-purpose processors, may be implemented as functionally-equivalent circuits such as a Digital Signal Processing (DSP) circuit or an Application-Specific Integrated Circuit (ASIC), or may be implemented in any other suitable manner. It should be appreciated that the flow charts included herein do not depict the syntax or operation of any particular circuit or of any particular programming language or type of programming language. Rather, the flow charts illustrate the functional information one skilled in the art may use to fabricate circuits or to implement computer software algorithms to perform the processing of a particular apparatus carrying out the types of techniques described herein. It should also be appreciated that, unless otherwise indicated herein, the particular sequence of steps and/or acts described in each flow chart is merely illustrative of the algorithms that may be implemented and can be varied in implementations and embodiments of the principles described herein.

Accordingly, in some embodiments, the techniques described herein may be embodied in computer-executable instructions implemented as software, including as application software, system software, firmware, middleware, embedded code, or any other suitable type of computer code. Such computer-executable instructions may be written using any of a number of suitable programming languages and/or programming or scripting tools, and also may be compiled as executable machine language code or intermediate code that is executed on a framework or virtual machine.

When techniques described herein are embodied as computer-executable instructions, these computer-executable instructions may be implemented in any suitable manner, including as a number of functional facilities, each providing one or more operations to complete execution of algorithms operating according to these techniques. A “functional facility,” however instantiated, is a structural component of a computer system that, when integrated with and executed by one or more computers, causes the one or more computers to perform a specific operational role. A functional facility may be a portion of or an entire software element. For example, a functional facility may be implemented as a function of a process, or as a discrete process, or as any other suitable unit of processing. If techniques described herein are implemented as multiple functional facilities, each functional facility may be implemented in its own way; all need not be implemented the same way. Additionally, these functional facilities may be executed in parallel and/or serially, as appropriate, and may pass information between one another using a shared memory on the computer(s) on which they are executing, using a message passing protocol, or in any other suitable way.

Generally, functional facilities include routines, programs, objects, components, data structures, etc. that perform particular tasks or implement particular abstract data types. Typically, the functionality of the functional facilities may be combined or distributed as desired in the systems in which they operate. In some implementations, one or more functional facilities carrying out techniques herein may together form a complete software package. These functional facilities may, in alternative embodiments, be adapted to interact with other, unrelated functional facilities and/or processes, to implement a software program application, for example as a software program application.

Some exemplary functional facilities have been described herein for carrying out one or more tasks. It should be appreciated, though, that the functional facilities and division of tasks described is merely illustrative of the type of functional facilities that may implement the exemplary techniques described herein, and that embodiments are not limited to being implemented in any specific number, division, or type of functional facilities. In some implementations, all functionality may be implemented in a single functional facility. It should also be appreciated that, in some implementations, some of the functional facilities described herein may be implemented together with or separately from others (i.e., as a single unit or separate units), or some of these functional facilities may not be implemented.

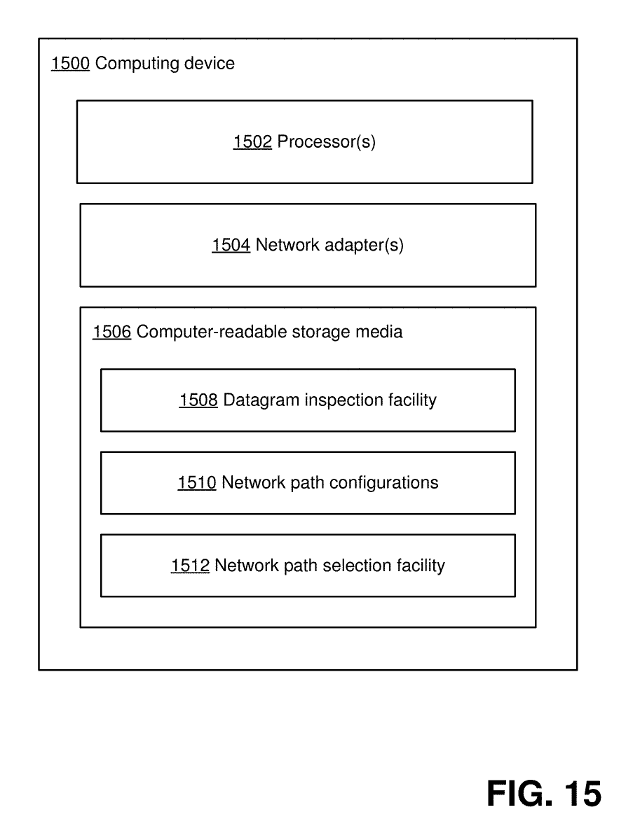

Computer-executable instructions implementing the techniques described herein (when implemented as one or more functional facilities or in any other manner) may, in some embodiments, be encoded on one or more computer-readable media to provide functionality to the media. Computer-readable media include magnetic media such as a hard disk drive, optical media such as a Compact Disk (CD) or a Digital Versatile Disk (DVD), a persistent or non-persistent solid-state memory (e.g., Flash memory, Magnetic RAM, etc.), or any other suitable storage media. Such a computer-readable medium may be implemented in any suitable manner, including as computer-readable storage media 1506 of FIG. 15 described below (i.e., as a portion of a computing device 1500) or as a stand-alone, separate storage medium. As used herein, “computer-readable media” (also called “computer-readable storage media”) refers to tangible storage media. Tangible storage media are non-transitory and have at least one physical, structural component. In a “computer-readable medium,” as used herein, at least one physical, structural component has at least one physical property that may be altered in some way during a process of creating the medium with embedded information, a process of recording information thereon, or any other process of encoding the medium with information. For example, a magnetization state of a portion of a physical structure of a computer-readable medium may be altered during a recording process.

In some, but not all, implementations in which the techniques may be embodied as computer-executable instructions, these instructions may be executed on one or more suitable computing device(s) operating in any suitable computer system, including the exemplary computer system of FIG. 1, or one or more computing devices (or one or more processors of one or more computing devices) may be programmed to execute the computer-executable instructions. A computing device or processor may be programmed to execute instructions when the instructions are stored in a manner accessible to the computing device or processor, such as in a data store (e.g., an on-chip cache or instruction register, a computer-readable storage medium accessible via a bus, a computer-readable storage medium accessible via one or more networks and accessible by the device/processor, etc.). Functional facilities comprising these computer-executable instructions may be integrated with and direct the operation of a single multi-purpose programmable digital computing device, a coordinated system of two or more multi-purpose computing device sharing processing power and jointly carrying out the techniques described herein, a single computing device or coordinated system of computing devices (co-located or geographically distributed) dedicated to executing the techniques described herein, one or more Field-Programmable Gate Arrays (FPGAs) for carrying out the techniques described herein, or any other suitable system.

FIG. 15 illustrates one exemplary implementation of a computing device in the form of a computing device 1500 that may be used in a system implementing techniques described herein, although others are possible. It should be appreciated that FIG. 15 is intended neither to be a depiction of necessary components for a computing device to operate as a security device or relay server in accordance with the principles described herein, nor a comprehensive depiction.

Computing device 1500 may comprise at least one processor 1502, a network adapter 1504, and computer-readable storage media 1506. Computing device 1500 may be, for example, a desktop or laptop personal computer, a personal digital assistant (PDA), a smart mobile phone, a server, a wireless access point or other networking element, or any other suitable computing device such as a security device, a relay server, or any other server. Network adapter 1504 may be any suitable hardware and/or software to enable the computing device 1500 to communicate wired and/or wirelessly with any other suitable computing device over any suitable computing network. The computing network may include wireless access points, switches, routers, gateways, and/or other networking equipment as well as any suitable wired and/or wireless communication medium or media for exchanging data between two or more computers, including the Internet. Computer-readable media 1506 may be adapted to store data to be processed and/or instructions to be executed by processor 1502. Processor 1502 enables processing of data and execution of instructions. The data and instructions may be stored on the computer-readable storage media 1506.

The data and instructions stored on computer-readable storage media 1506 may comprise computer-executable instructions implementing techniques which operate according to the principles described herein. In the example of FIG. 15, computer-readable storage media 1506 stores computer-executable instructions implementing various facilities and storing various information as described above. Computer-readable storage media 1506 may store datagram inspection facility 1508 for inspecting traffic flows, network path configurations 1510 for establishing, configuring, and utilizing multiple network paths, and a network path selection facility 112 for selectively routing traffic flows over a network path.

While not illustrated in FIG. 15, a computing device may additionally have one or more components and peripherals, including input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computing device may receive input information through speech recognition or in other audible format.

Embodiments have been described where the techniques are implemented in circuitry and/or computer-executable instructions. It should be appreciated that some embodiments may be in the form of a method, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Various aspects of the embodiments described above may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” “having,” “containing,” “involving,” and variations thereof herein, is meant to encompass the items listed thereafter and equivalents thereof as well as additional items.

The word “exemplary” is used herein to mean serving as an example, instance, or illustration. Any embodiment, implementation, process, feature, etc. described herein as exemplary should therefore be understood to be an illustrative example and should not be understood to be a preferred or advantageous example unless otherwise indicated.

Having thus described several aspects of at least one embodiment, it is to be appreciated that various alterations, modifications, and improvements will readily occur to those skilled in the art. Such alterations, modifications, and improvements are intended to be part of this disclosure, and are intended to be within the spirit and scope of the principles described herein. Accordingly, the foregoing description and drawings are by way of example only.

What is claimed is:

What is claimed is:

1. A method comprising:
selectively securing a plurality of outbound traffic flows based on one or more characteristics of each traffic flow, the plurality of outbound traffic flows being outbound from a first network associated with a premises, the selectively securing comprising:
intercepting the plurality of outbound traffic flows at a boundary between the network associated with the premises and a second network to which the plurality of outbound traffic flows are communicated; and
for each traffic flow of the plurality of outbound traffic flows,
selecting one or more security parameters for the traffic flow based on one or more characteristics of the traffic flow; and
securing the traffic flow at least in part by transmitting the traffic flow to the second network according to the one or more security parameters.

2. The method of claim 1, wherein selecting the one or more security parameters for the traffic flow based on the one or more characteristics of the traffic flow comprises selecting a network tunnel, from among a plurality of network tunnels, via which to transmit the traffic flow, wherein each network tunnel of the plurality of network tunnels is associated with different sets of one or more security parameters.

3. The method of claim 2, wherein selecting the network tunnel of the plurality of network tunnels comprises selecting the network tunnel based on the one or more characteristics of the traffic flow.

4. The method of claim 3, wherein selecting the one or more security parameters for the traffic flow comprises, in response to determining that the one or more characteristics of the traffic flow satisfy one or more criteria, transmitting the traffic flow to the second network without transmitting the traffic flow via any of the plurality of network tunnels.

5. The method of claim 1, wherein:
selecting the one or more security parameters for the traffic flow comprises selecting, for a first traffic flow of the plurality of outbound traffic flows, that encryption is to be applied to the first traffic flow; and
transmitting the traffic flow to the second network according to the one or more security parameters comprises encrypting the first traffic flow to produce an encrypted traffic flow and transmitting the encrypted traffic flow to the second network.

6. The method of claim 5, wherein:
the first traffic flow is being communicated from the first network to a first destination; and
transmitting the encrypted traffic flow comprises establishing a network connection to a second destination different from the first destination; and
transmitting the encrypted traffic flow comprises transmitting the first traffic flow via the encrypted traffic flow for transmission to the first destination via the second destination.

7. The method of claim 5, wherein:
selecting one or more security parameters for each traffic flow comprises, for each traffic flow, determining whether encryption is to be used for the traffic flow; and
the selecting that encryption is to be applied to the first traffic flow is performed in response to determining, for the first traffic flow, that encryption is to be used.

8. The method of claim 7, wherein:
determining, for each traffic flow, whether encryption is going to be used comprises determining, for a second traffic flow of the plurality of outbound traffic flows, that encryption is not to be used;
securing the second traffic flow at least in part by transmitting the second traffic flow to the second network according to the one or more security parameters comprises transmitting the second traffic flow to the second network without encryption.

9. The method of claim 8, wherein:
selecting the one or more security parameters for the second traffic flow, based on the one or more characteristics of the second traffic flow, comprises selecting that no additional security is to be applied to the second traffic flow; and
securing the second traffic flow according to the one or more security parameters comprises transmitting the second traffic flow in a same manner as the second traffic flow is received.

10. The method of claim 1, wherein selecting one or more security parameters based on one or more characteristics of the traffic flow and securing the traffic flow according to the one or more security parameters comprises selecting one or more security parameters to be applied to the traffic flow in addition to any security already used for the traffic flow and securing

11. The method of claim 10, wherein selecting one or more security parameters to be applied to the traffic flow, based on the one or more characteristics, comprises selecting the one or more security parameters based at least in part on security characteristics of the traffic flow.

12. The method of claim 1, wherein the one or more security parameters comprise parameters for encrypting and/or compressing the traffic flow.

13. The method of claim 1, wherein the selectively securing is performed by a device disposed in the first network associated with the premises.

14. The method of claim 1, wherein:
there is a network gateway between the first network and the second network; and
the device is disposed on the first network side of the network gateway.

15. An apparatus to be connected between one or more devices of a first network associated with a premises and a second network by which the one or more devices of the first network communicate to the Internet, the apparatus comprising:
at least one processor; and
at least one storage medium having encoded thereon executable instructions that, when executed by the at least one processor, cause the at least one processor to carry out a method comprising:
selectively securing a plurality of outbound traffic flows based on one or more characteristics of each traffic flow, the plurality of outbound traffic flows being outbound from the one or more devices of the first network to the second network, the selectively securing comprising:
intercepting the plurality of outbound traffic flows with the apparatus; and
for each traffic flow of the plurality of outbound traffic flows,
selecting one or more security parameters for the traffic flow based on one or more characteristics of the traffic flow; and
securing the traffic flow at least in part by transmitting the traffic flow to the second network according to the one or more security parameters.

16. A network associated with a premises, the network comprising:
a gateway to interface between the network and a second network, the second network providing the network with access to the Internet;
one or more devices connected to the network and transmitting data to be received by the one or more devices and/or to be communicated to the second network; and
a device connected between the one or more devices and the gateway, the device being configured to carry out a method of:
intercepting a plurality of outbound traffic flows from the one or more devices to the second network, each of the traffic flows being directed to one or more destinations other than the device;
selectively securing the plurality of outbound traffic flows based on one or more characteristics of each traffic flow, the selectively securing comprising, for each traffic flow of the plurality of outbound traffic flows:
in response to determining that the one or more characteristics satisfy at least one first criteria, transmitting the traffic flow to the gateway for transmission to the second network;
in response to determining that the one or more characteristics satisfy at least one second criteria, transmitting the traffic flow to the gateway and to a first destination of the traffic flow via a first tunnel, the first tunnel terminating at a second destination different from the first destination of the traffic flow; and
in response to determining that the one or more characteristics satisfy at least one third criteria, transmitting the traffic flow to the gateway and to the first destination of the traffic flow via a second tunnel, the second tunnel terminating at a third destination different from the first destination of the traffic flow,
wherein the first tunnel and the second tunnel are associated with different security parameters.

17. A method comprising:
in response to intercepting a message requesting that a first computing device associated with a first numeric network address provide a corresponding numeric network address that corresponds to a network name,
editing the message to direct the message to a second computing device associated with a second numeric network address and request that the second computing device provide a corresponding numeric network address that corresponds to the network name; and
transmitting the message to the second computing device.

18. The method of claim 17, wherein the first numeric network address, the second numeric network address, and the corresponding numeric network address are Internet Protocol (IP) addresses.

19. The method of claim 18, wherein the network name is a domain name.

20. The method of claim 19, wherein:
the message requesting that the first computing device provide the corresponding numeric network address that corresponds to the network name is a Domain Name System (DNS) request;
the first computing device is a first DNS server; and
the second computing device is a second DNS server.

21. The method of claim 17, wherein editing the message comprises:
editing a destination address of the message to replace the first numeric network address with the second numeric network address, without editing a source address of the message.

22. The method of claim 21, further comprising:
receiving a response to the message, the response including the corresponding numeric network address and having a destination address that is the source address of the message; and
transmitting the response to the source address of the message.

23. The method of claim 22, wherein the corresponding numeric network address of the response is a network address that differs from a network address that would be received in a response from the first computing device.

24. The method of claim 23, further comprising:
in response to intercepting a second message requesting that the first computing device associated with the first numeric network address provide a second corresponding numeric network address that corresponds to a second network name,
editing the second message to direct the second message to the second computing device associated with the second numeric network address and request that the second computing device provide a second corresponding numeric network address that corresponds to the second network name; and
transmitting the second message to the second computing device; and
receiving a second response to the second message, the second response including the second corresponding numeric network address, wherein the second corresponding numeric network address of the second response is a same network address that would be received in a second response from the first computing device; and
transmitting the second response to a source address of the second message.

25. The method of claim 17, further comprising:
receiving, in response to the message, category information indicative of a categorization of content associated with the network name.

26. The method of claim 25, further comprising:
responsive to receipt of the category information, refraining from transmitting the corresponding numeric network address to a source address of the message.

27. A system comprising:
a first computing device, the first computing device being configured to perform a first method comprising:
in response to receipt of a request for a numeric network address corresponding to a network name,
determining a categorization of content associated with the network name; and
based on the categorization, selectively responding to the request with either the numeric network address corresponding to the network name or a second numeric network address that does not correspond to the network name; and
a second computing device, the second computing device being configured to perform a second method comprising:
in response to intercepting a first message requesting that a third computing device associated with a first numeric network address provide a corresponding numeric network address that corresponds to an identified network name,
edit the first message to direct the first message to the first computing device and request that the first computing device provide the corresponding numeric network address that corresponds to the identified network name; and
transmit the first message to the first computing device.

28. The system of claim 27, further comprising:
a gateway to interface between a first network and a second network, the second network providing the first network with access to the Internet;
a fourth computing device connected to the first network, the third computing device being a source of the first message,
wherein the second computing device is connected disposed on the first network side of the gateway, and
wherein the first computing device is connected to the second computing device and the first network via the second network.

29. A method comprising:
requesting configuration information from a server;
receiving, in response to the request, a plurality of sets of security parameters;
selecting one of the plurality of sets of security parameters; and
selecting, from a plurality of relay servers, a relay server to be used as a destination of traffic flows secured using the selected set of security parameters.

30. The method of claim 29, wherein selecting a relay server to be used as a destination of traffic flows secured using the selected set of security parameters comprises:
measuring respective network latencies to a plurality of relay servers identified by the plurality of sets of security parameters; and
establishing a network connection with a relay server assigned by a load balancing server based at least in part on the measured network latencies.

31. The method of claim 29, wherein the request comprises any of an authorization key, a device identifier, and/or data indicating a device operation mode.

32. The method of claim 29, wherein the plurality of sets of security parameters comprises information for establishing a VPN connection with a respective relay server.

33. The method of claim 29, wherein at least one of the plurality of relay servers comprises a pool of relay servers.

34. A system comprising:
a first computing device, the first computing device being configured to perform a first method comprising:
requesting configuration information from a server;
receiving, in response to the request, a plurality of sets of security parameters; and
selecting one of the plurality of sets of security parameters;
selecting, from a plurality of relay servers, a relay server to be used as a destination of traffic flows secured using the selected set of security parameters.

35. The system of claim 34, wherein selecting a relay server to be used as a destination of traffic flows secured using the selected set of security parameters comprises:
measuring respective network latencies to a plurality of relay servers identified by the plurality of sets of security parameters; and
establishing a network connection with a relay server assigned by a load balancing server based at least in part on the measured network latencies.

36. The system of claim 34, wherein the request comprises any of an authorization key, a device identifier, and/or data indicating a device operation mode.

37. The system of claim 34, wherein the plurality of sets of security parameters comprises information for establishing a VPN connection with a respective relay server.

38. The system of claim 34, wherein at least one of the plurality of relay servers comprises a pool of relay servers.
